(19) United States
(12) Patent Application Publication
(10) Pub. No.: US 2022/0155927 A1
(43) Pub. Date: May 19, 2022

(54) DATA VISUALIZATION APPARATUS, DATA PROCESSING METHOD, AND NON-TRANSITORY COMPUTER-READABLE STORAGE MEDIUM

(71) Applicant: Sumitomo Electric Industries, Ltd., Osaka-shi, Osaka (JP)

(72) Inventor: Takashi YAMAMOTO, Osaka-shi, Osaka (JP)

(73) Assignee: Sumitomo Electric Industries, Ltd., Osaka-shi, Osaka (JP)

(21) Appl. No.: 17/602,779

(22) PCT Filed: Apr. 1, 2020
(86) PCT No.: PCT/JP2020/015009

§ 371 Date: Oct. 11, 2021

(30) Foreign Application Priority Data
Apr. 12, 2019 (JP) 2019-076414

(51) Int. Cl. G06F 3/0484

(52) U.S. Cl. CPC G06F 3/0484

(57) ABSTRACT

A data visualization apparatus includes a data obtaining unit that obtains, from a database, target data that is at least one of measurement data or a calculation result of calculation using the measurement data and a processing unit that performs, based on the target data obtained by the data obtaining unit, processing of creating a confirmation screen including the measurement data or the calculation result and processing of causing the confirmation screen to be displayed, wherein the processing unit includes a display component creating unit that creates or updates one or more display components constituting the confirmation screen, and a confirmation screen creating unit that creates or updates the confirmation screen by disposing the one or more display components created by the display component creating unit. A data processing method for a data visualization apparatus, and a non-transitory computer-readable storage medium storing are also provided.

### TECHNICAL FIELD

The present disclosure relates to a data visualization apparatus, a data processing method, and a data processing program.

The present application claims the priority based on Japanese Patent Application No. 2019-76414 filed on Apr. 12, 2019, the entire contents of which are incorporated herein by reference.

### BACKGROUND ART

Japanese Patent Application Laid-Open No. 2019-003691 (PTL 1) discloses the following technique. That is, a management apparatus includes: a first obtaining unit that obtains a measurement result by a sensor performing measurement for a facility and a time corresponding to the measurement result; a second obtaining unit that obtains a plurality of use periods of the facility and contents of management items corresponding to each of the use periods from a storage unit; and a data processing unit that performs processing of summarizing measurement information based on the measurement result for each of the contents, based on the measurement result and the corresponding time obtained by the first obtaining unit, and the contents and the corresponding use periods obtained by the second obtaining unit.

### CITATION LIST

### Patent Literature

PTL 1: Japanese Patent Application Laid-Open No. 2019-3691

### SUMMARY OF INVENTION

A data visualization apparatus according to the present disclosure includes a data obtaining unit that obtains, from a database, target data that is at least one of measurement data or a calculation result of calculation using the measurement data and a processing unit that performs, based on the target data obtained by the data obtaining unit, processing of creating a confirmation screen including the measurement data or the calculation result and processing of causing the confirmation screen to be displayed, wherein the processing unit includes a display component creating unit that creates or updates one or more display components constituting the confirmation screen, and a confirmation screen creating unit that creates or updates the confirmation screen by disposing the one or more display components created by the display component creating unit, wherein the display component creating unit is capable of changing content of each of the one or more display components in accordance with one or more parameters, and wherein the confirmation screen creating unit is capable of selecting, using the one or more parameters, content of each of the one or more display components in the confirmation screen.

A data visualization apparatus according to the present disclosure includes a data obtaining unit that obtains, from a database, target data that is at least one of measurement data or a calculation result of calculation using the measurement data and a processing unit that performs, based on the target data obtained by the data obtaining unit, processing of creating a confirmation screen including the measurement data or the calculation result and processing of causing the confirmation screen to be displayed, wherein the processing unit includes a display component creating unit that creates or updates one or more display components constituting the confirmation screen, and a confirmation screen creating unit that creates or updates the confirmation screen by disposing the one or more display components created by the display component creating unit, wherein the confirmation screen creating unit is capable of creating a plurality of the confirmation screens, and wherein the processing unit performs processing of causing one screen to display a list of one or more types of the one or more display components and a list of types of the confirmation screens.

A data processing method according to the present disclosure is a data processing method for a data visualization apparatus, wherein the data processing method includes obtaining, from a database, target data that is at least one of measurement data or a calculation result of calculation using the measurement data, performing, based on the target data that has been obtained, processing of creating a confirmation screen including the measurement data or the calculation result and processing of causing the confirmation screen to be displayed, creating or updating one or more display components constituting the confirmation screen, and creating or updating the confirmation screen by disposing the one or more display components, wherein content of each of the one or more display components is changed in accordance with one or more parameters, and wherein content of each of the one or more display components in the confirmation screen is selected using the one or more parameters.

A data processing method according to the present disclosure is a data processing method for a data visualization apparatus, wherein the data processing method includes obtaining, from a database, target data that is at least one of measurement data or a calculation result of calculation using the measurement data, performing, based on the target data that has been obtained, processing of creating a confirmation screen including the measurement data or the calculation result and processing of causing the confirmation screen to be displayed, creating or updating one or more display components constituting the confirmation screen, and creating or updating the confirmation screen by disposing the one or more display components, wherein a plurality of the confirmation screens are created, and wherein processing of causing one screen to display a list of one or more types of the one or more display components and a list of types of the confirmation screens is performed.

A data processing program according to the present disclosure is a data processing program used in a data visualization apparatus, wherein the data processing program causes a computer to obtain, from a database, target data that is at least one of measurement data or a calculation result of calculation using the measurement data, perform, based on the target data that has been obtained, processing of creating a confirmation screen including the measurement data or the calculation result and processing of causing the confirmation screen to be displayed, create or update one or more display components constituting the confirmation screen, and create or update the confirmation screen by disposing the one or more display components, wherein content of each of the one or more display components is caused to be changed in accordance with one or more parameters, and wherein content of each of the one or more display components in the confirmation screen is caused to be selected using the one or more parameters.

A data processing program according to the present disclosure is a data processing program used in a data visualization apparatus, wherein the data processing program causes a computer to obtain, from a database, target data that is at least one of measurement data or a calculation result of calculation using the measurement data, perform, based on the target data that has been obtained, processing of creating a confirmation screen including the measurement data or the calculation result and processing of causing the confirmation screen to be displayed, create or update one or more display components constituting the confirmation screen, and create or update the confirmation screen by disposing the one or more display components, wherein a plurality of the confirmation screens are caused to be created, and wherein processing of causing one screen to display a list of one or more types of the one or more display components and a list of types of the confirmation screens is caused to be performed.

An embodiment according to the present disclosure can be implemented not only as a data visualization apparatus including such characteristic processing units, but also as a semiconductor integrated circuit that implements a part or all of the data visualization apparatus, or as a system including the data visualization apparatus.

### BRIEF DESCRIPTION OF DRAWINGS

FIG. 1 is a diagram illustrating a configuration of a management system according to an embodiment of the present disclosure.

FIG. 2 is a diagram illustrating an example of a type and a range of authority of a user in the management system according to the embodiment of the present disclosure.

FIG. 3 is a diagram illustrating an example of possible processing for each user type in the management system according to the embodiment of the present disclosure.

FIG. 4 is a diagram illustrating another example of possible processing for each user type in the management system according to the embodiment of the present disclosure.

FIG. 5 is a diagram illustrating an example of a top screen displayed on a display in the management system according to the embodiment of the present disclosure.

FIG. 6 is a diagram illustrating an example of a selection screen displayed on a display in the management system according to the embodiment of the present disclosure.

FIG. 7 is a diagram illustrating an example of a detailed screen displayed on a display in the management system according to the embodiment of the present disclosure.

FIG. 8 is a diagram illustrating an example of an initial setting screen displayed on a display in the management system according to the embodiment of the present disclosure.

FIG. 9 is a diagram illustrating an example of a component editing screen displayed on a display in the management system according to the embodiment of the present disclosure.

FIG. 10 is a diagram illustrating an example of a dataConfig screen displayed on a display in the management system according to the embodiment of the present disclosure.

FIG. 11 is a diagram illustrating an example of a display component in the management system according to the embodiment of the present disclosure.

FIG. 12 is a diagram illustrating an example of a display component in the management system according to the embodiment of the present disclosure.

FIG. 13 is a diagram illustrating an example of a display component in the management system according to the embodiment of the present disclosure.

FIG. 14 is a diagram illustrating an example of a layout screen displayed on the display in the management system according to the embodiment of the present disclosure.

FIG. 15 is a diagram illustrating an example of a screen on which the display component is disposed on the layout screen in the management system according to the embodiment of the present disclosure.

FIG. 16 is a diagram illustrating an example of a content selection screen displayed on the display in the management system according to the embodiment of the present disclosure.

FIG. 17 is a diagram illustrating an example of a screen on which the display component is disposed in the layout screen in the management system according to the embodiment of the present disclosure.

FIG. 18 is a diagram illustrating an example of a layout screen on which a plurality of display components are disposed in the management system according to the embodiment of the present disclosure.

FIG. 19 is a diagram illustrating an example of a parameter setting screen in the management system according to the embodiment of the present disclosure.

FIG. 20 is a diagram illustrating another example of a parameter setting screen in the management system according to the embodiment of the present disclosure.

FIG. 21 is a diagram illustrating another example of a top screen displayed on a display in the management system according to the embodiment of the present disclosure.

FIG. 22 is a diagram illustrating an example of a layout screen on which a plurality of types of display components are disposed in the management system according to the embodiment of the present disclosure.

FIG. 23 is a diagram illustrating an example of a layout screen on which a plurality of types of display components are disposed in the management system according to the embodiment of the present disclosure.

FIG. 24 is a diagram illustrating an example of a layout screen on which a plurality of types of display components are disposed in the management system according to the embodiment of the present disclosure.

FIG. 25 is a diagram illustrating an example of a layout screen on which a plurality of types of display components are disposed in the management system according to the embodiment of the present disclosure.

FIG. 26 is a diagram schematically illustrating a use of video in the management system according to the embodiment of the present disclosure.

FIG. 27 is a diagram illustrating an example of a user management screen displayed on the display in the management system according to the embodiment of the present disclosure.

FIG. 28 is a diagram illustrating an example of a user management screen including a user group name, which is displayed on a display in the management system according to the embodiment of the present disclosure.

FIG. 29 is a diagram illustrating an example of a user management screen including a user group table displayed on a display in the management system according to the embodiment of the present disclosure.

FIG. 30 is a flowchart defining an operation procedure when the data visualization apparatus in the management system according to the embodiment of the present disclosure displays a confirmation screen on a display.

FIG. 31 is a diagram illustrating a state in which a confirmation screen is selected on a top screen in the management system according to the embodiment of the present disclosure.

FIG. 32 is a diagram illustrating a state in which a display component is selected on a top screen in the management system according to the embodiment of the present disclosure.

FIG. 33 is a diagram illustrating another example of a component editing screen displayed on a display in the management system according to the embodiment of the present disclosure.

FIG. 34 is a diagram illustrating an example of a component editing screen which is capable of performing an open setting displayed on a display according to the embodiment of the present disclosure.

FIG. 35 is a diagram illustrating an example of an open setting screen displayed on a display according to the embodiment of the present disclosure.

FIG. 36 is a diagram illustrating an example of a user open setting screen displayed on a display according to the embodiment of the present disclosure.

### DETAILED DESCRIPTION

Conventionally, a technique for monitoring the state of a facility using a measurement result of a sensor has been developed.

### Problems to be Solved by Present Disclosure

In the system including the above-described management apparatus, it is considered that the measurement result by the sensor, the measurement information based on the measurement result, and the like are stored in a database provided outside the management apparatus.

When a user uses the database, the user searches for necessary information from information stored in the database. However, if the user does not have sufficient expertise in the database, it is not easy to smoothly use the database to search for necessary information. Furthermore, if the amount of information stored in the database increases, search process becomes complicated. It is desirable to have a technology that can improve user convenience in a configuration of visualizing the information stored in the database.

An object of the present disclosure is to provide a data visualization apparatus, a data processing method, and a data processing program that can improve user convenience in a configuration in which measurement data obtained from a database is visualized.

### Advantageous Effects of Present Disclosure

According to the present disclosure, user convenience can be improved in a configuration in which measurement data obtained from a database is visualized.

### DESCRIPTION OF EMBODIMENTS OF PRESENT DISCLOSURE

First, contents of embodiments according to the present disclosure will be listed and described.

(1) A data visualization apparatus according to an embodiment of the present disclosure includes a data obtaining unit that obtains, from a database, target data that is at least one of measurement data or a calculation result of calculation using the measurement data and a processing unit that performs, based on the target data obtained by the data obtaining unit, processing of creating a confirmation screen including the measurement data or the calculation result and processing of causing the confirmation screen to be displayed, wherein the processing unit includes a display component creating unit that creates or updates one or more display components constituting the confirmation screen, and a confirmation screen creating unit that creates or updates the confirmation screen by disposing the one or more display components created by the display component creating unit, wherein the display component creating unit is capable of changing content of each of the one or more display components in accordance with one or more parameters, and wherein the confirmation screen creating unit is capable of selecting, using the one or more parameters, content of each of the one or more display components in the confirmation screen.

With this configuration, various confirmation screens corresponding to various applications can be easily created, and also various display components can be displayed on the confirmation screen by setting parameters. In a state where a plurality of types of display components having different parameter values are created, content of the plurality of types of display components can be changed at a time by changing a value of a parameter different from the parameter. Therefore, in a configuration in which the measurement data obtained from the database is visualized, user convenience can be improved.

(2) Preferably, the confirmation screen creating unit is capable of creating the confirmation screen in which a plurality of types of display components are disposed using the one or more parameters.

With this configuration, since various display components can be displayed on one confirmation screen, a screen with a larger amount of information can be provided to a user.

(3) Preferably, the confirmation screen creating unit is capable of creating a plurality of the confirmation screens, and the processing unit performs processing of causing one screen to display a list of one or more types of the one or more display components and a list of types of the confirmation screens and further performs, in accordance with an operation by a user, processing of displaying the one or more display components constituting each of the confirmation screens such that the one or more display components are recognizable.

With this configuration, it is possible to easily grasp each display component and each confirmation screen, which are targeted by the data visualization apparatus, as a whole. Further, the user can easily grasp a correspondence between display components and confirmation screens.

(4) Preferably, the processing unit performs processing of displaying an editing screen for the one or more display components and displays, on the editing screen, a usage status of the one or more display components in the confirmation screen.

With this configuration, it is easy for a user to know where the edit of the display components will affect.

(5) Preferably, the data obtaining unit further obtains identification information of a user, and the data visualization apparatus further includes a restriction unit that, in update of the one or more display components by the display component creating unit, limits the update performed by a user different from a user who has created the one or more display components, based on the identification information obtained by the data obtaining unit.

With this configuration, it is possible to limit the update of the display components separately from authority and to suppress interference between users.

(6) A data visualization apparatus according to an embodiment of the present disclosure includes a data obtaining unit that obtains, from a database, target data that is at least one of measurement data or a calculation result of calculation using the measurement data and a processing unit that performs, based on the target data obtained by the data obtaining unit, processing of creating a confirmation screen including the measurement data or the calculation result and processing of causing the confirmation screen to be displayed, wherein the processing unit includes a display component creating unit that creates or updates one or more display components constituting the confirmation screen, and a confirmation screen creating unit that creates or updates the confirmation screen by disposing the one or more display components created by the display component creating unit, wherein the confirmation screen creating unit is capable of creating a plurality of the confirmation screens, and wherein the processing unit performs processing of causing one screen to display a list of one or more types of the one or more display components and a list of types of the confirmation screens.

With this configuration, various confirmation screens corresponding to various applications can be easily created, and also it is possible to easily grasp each display component and each confirmation screen, which are targeted by the data visualization apparatus, as a whole. Therefore, in a configuration in which the measurement data obtained from the database is visualized, user convenience can be improved.

(7) A data processing method according to an embodiment of the present disclosure is a data processing method for a data visualization apparatus, wherein the data processing method includes obtaining, from a database, target data that is at least one of measurement data or a calculation result of calculation using the measurement data, performing, based on the target data that has been obtained, processing of creating a confirmation screen including the measurement data or the calculation result and processing of causing the confirmation screen to be displayed, creating or updating one or more display components constituting the confirmation screen, and creating or updating the confirmation screen by disposing the one or more display components, wherein content of each of the one or more display components is changed in accordance with one or more parameters, and wherein content of each of the one or more display components in the confirmation screen is selected using the one or more parameters.

With this configuration, various confirmation screens corresponding to various applications can be easily created, and also various display components can be displayed on the confirmation screen by setting parameters. In a state where a plurality of types of display components having different parameter values are created, content of the plurality of types of display components can be changed at a time by changing a value of a parameter different from the parameter. Therefore, in a configuration in which the measurement data obtained from the database is visualized, user convenience can be improved.

(8) A data processing method according to an embodiment of the present disclosure is a data processing method for a data visualization apparatus, wherein the data processing method includes obtaining, from a database, target data that is at least one of measurement data or a calculation result of calculation using the measurement data, performing, based on the target data that has been obtained, processing of creating a confirmation screen including the measurement data or the calculation result and processing of causing the confirmation screen to be displayed, creating or updating one or more display components constituting the confirmation screen, and creating or updating the confirmation screen by disposing the one or more display components, wherein a plurality of the confirmation screens are created, and wherein processing of causing one screen to display a list of one or more types of the one or more display components and a list of types of the confirmation screens is performed.

With this configuration, various confirmation screens corresponding to various applications can be easily created, and also it is possible to easily grasp each display component and each confirmation screen, which are targeted by the data visualization apparatus, as a whole. Therefore, in a configuration in which the measurement data obtained from the database is visualized, user convenience can be improved.

(9) A data processing program according to an embodiment of the present disclosure is a data processing program used in a data visualization apparatus, wherein the data processing program causes a computer to obtain, from a database, target data that is at least one of measurement data or a calculation result of calculation using the measurement data, perform, based on the target data that has been obtained, processing of creating a confirmation screen including the measurement data or the calculation result and processing of causing the confirmation screen to be displayed, create or update one or more display components constituting the confirmation screen, and create or update the confirmation screen by disposing the one or more display components, wherein content of each of the one or more display components is caused to be changed in accordance with one or more parameters, and wherein content of each of the one or more display components in the confirmation screen is caused to be selected using the one or more parameters.

$$[ 0035 ]$$

With this configuration, various confirmation screens corresponding to various applications can be easily created, and also various display components can be displayed on the confirmation screen by setting parameters. In a state where a plurality of types of display components having different parameter values are created, content of the plurality of types of display components can be changed at a time by changing a value of a parameter different from the parameter. Therefore, in a configuration in which the measurement data obtained from the database is visualized, user convenience can be improved.

(10) A data processing program according to an embodiment of the present disclosure is a data processing program used in a data visualization apparatus, wherein the data processing program causes a computer to obtain, from a database, target data that is at least one of measurement data or a calculation result of calculation using the measurement data, perform, based on the target data that has been obtained, processing of creating a confirmation screen including the measurement data or the calculation result and processing of causing the confirmation screen to be displayed, create or update one or more display components constituting the confirmation screen, and create or update the confirmation screen by disposing the one or more display components, wherein a plurality of the confirmation screens are caused to be created, and wherein processing of causing one screen to display a list of one or more types of the one or more display components and a list of types of the confirmation screens is caused to be performed.

With this configuration, various confirmation screens corresponding to various applications can be easily created, and also it is possible to easily grasp each display component and each confirmation screen, which are targeted by the data visualization apparatus, as a whole. Therefore, in a configuration in which the measurement data obtained from the database is visualized, user convenience can be improved.

Hereinafter, embodiments according to the present disclosure will be described with reference to the drawings. In the description of the drawings, like or corresponding elements are remarked by like reference numerals and redundant descriptions thereof will be omitted. At least some of the embodiments described below may be arbitrarily combined.

### [Configuration and Basic Operation]

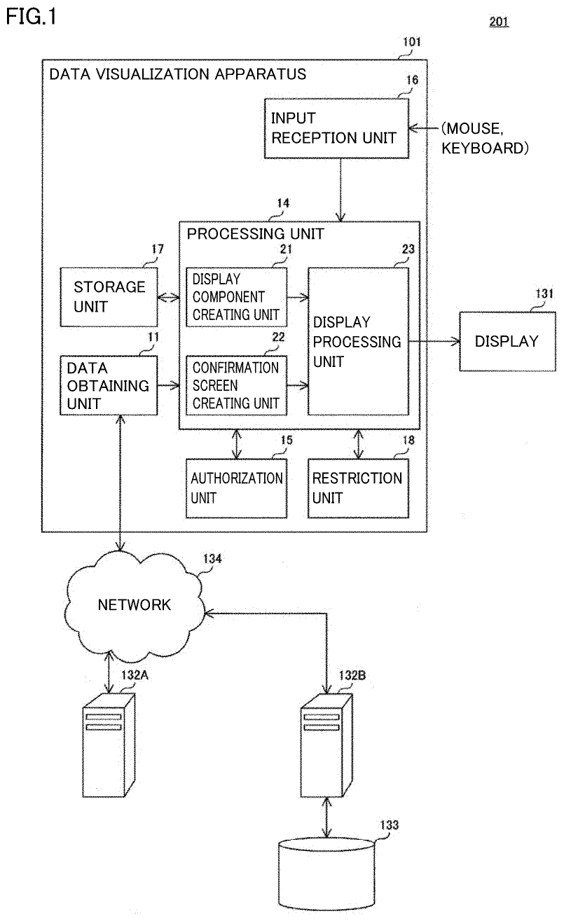

FIG. 1 is a diagram illustrating a configuration of a management system according to an embodiment of the present disclosure.

Referring to FIG. 1, a management system 201 includes a data visualization apparatus 101, a display 131, servers 132A and 132B, and a database 133.

Server 132A is, for example, a Web server. Server 132B is, for example, a REST (Representational State Transfer) API (Web Application Programming Interface) server. Server 132A and server 132B implement different Web APIs from each other.

More specifically, each of server 132A and server 132B prepares a URL (Uniform Resource Locator) for each processing, and receives a command such as a request, a response, or a post which are in accordance with an http (Hypertext Transfer Protocol) at the URL to perform processing in accordance with the received command.

In database 133, for example, measurement data based on measurement results by one or more sensors (not illustrated) is stored. The measurement data includes, for example, a flow rate, a temperature, a measurement time, a measurement location, a sensor lot number, and the like.

Server 132B obtains the measurement data from database 133 in accordance with the command, for example. Server 132B performs a calculation using the obtained measurement data in accordance with the command, for example.

Data visualization apparatus 101 obtains target data, which is at least one of the measurement data and the calculation result of calculation using the measurement data, from database 133 via a network 134 such as the Internet and server 132B, and displays a screen based on the obtained target data on display 131.

Data visualization apparatus 101 and display 131 may be integrated. Network 134 may be a network other than the Internet, such as a local network.

### [Data Visualization Apparatus]

Data visualization apparatus 101 includes a data obtaining unit 11, a processing unit 14, an authorization unit 15, an input reception unit 16, a storage unit 17, and a restriction unit 18. Processing unit 14 includes a display component creating unit 21, a confirmation screen creating unit 22, and a display processing unit 23.

Data obtaining unit 11 obtains the target data. Based on the target data obtained by data obtaining unit 11, processing unit 14 performs processing of displaying content related to the measurement data on a confirmation screen, that is, performs processing of creating a confirmation screen including the measurement data or the calculation result and processing of causing display 131 to display the confirmation screen.

For example, in processing unit 14, display component creating unit 21 creates or updates one or more display components that constitute the confirmation screen in accordance with an instruction from a user.

For example, confirmation screen creating unit 22 creates or updates the confirmation screen by disposing the display components created by display component creating unit 21 in accordance with an instruction from a user.

For example, display processing unit 23 performs processing of displaying the confirmation screen on display 131 in accordance with an instruction from a user.

Storage unit 17 stores, for example, a plurality of OSS (Open Source Software) libraries for creating the corresponding display components.

The OSS libraries are, for example, flot for creating a graph and gantt-chart-d3 for creating a gantt chart.

Input reception unit 16 receives, for example, an input operation by a user via a keyboard or a mouse.

Upon receiving the input operation by the user, input reception unit 16 outputs information indicating the received input content to processing unit 14.

More specifically, when data visualization apparatus 101 is activated and a predetermined operation is performed by the user via a keyboard, a mouse, or the like, for example, input reception unit 16 outputs operation information indicating the content of the operation performed by the user to processing unit 14.

Processing unit 14 transmits an http request to server 132A based on the operation information received from input reception unit 16.

More specifically, processing unit 14 creates an http request including a URLa for login processing based on the operation information received from input reception unit 16, and outputs the created http request and the operation information to data obtaining unit 11.

Data obtaining unit 11 transmits the http request received from processing unit 14 to server 132A.

Upon receiving the http request from data visualization apparatus 101, server 132A creates an http response including an HTML (HyperText Markup Language) file including a GUI (Graphical User Interface) for login processing based on the received http request, and transmits the created http response to data visualization apparatus 101.

Upon receiving the http response from server 132A, data visualization apparatus 101 performs, based on the received http response, processing of displaying, on display 131, a screen on which the GUI for login processing is drawn on a Web browser.

More specifically, data obtaining unit 11 in data visualization apparatus 101 receives the http response transmitted from server 132A, obtains the HTML file from the received http response, and outputs the HTML file to processing unit 14.

Processing unit 14 obtains the GUI for login processing included in the HTML file received from data obtaining unit 11, creates a screen on which the obtained GUI for login processing is drawn on the Web browser, and displays the created screen on display 131.

For example, a user inputs his or her own “user ID (Identification)” and “password” in fields for inputting “user ID” and “password” in the GUI for login processing displayed on display 131, and performs an operation of transmitting them to server 132A to the Web browser.

Upon receiving the operation by the user, input reception unit 16 outputs a received input content, that is, the “user ID” and the “password” to processing unit 14.

Processing unit 14 creates an http post including the “user ID” and the “password” based on the input content received from input reception unit 16, and transmits the created http post to server 132A via data obtaining unit 11.

Server 132A receives the http post from data visualization apparatus 101 and executes the login processing based on the received http post.

In the login processing, server 132A determines whether to permit the login of the user having the user ID based on the “user ID” and the “password” included in the http post.

Then, when server 132A determines to permit the login of the user having the user ID, server 132A creates, for example, an http cookie indicating the user ID and a type of user, and transmits the created http cookie to data visualization apparatus 101.

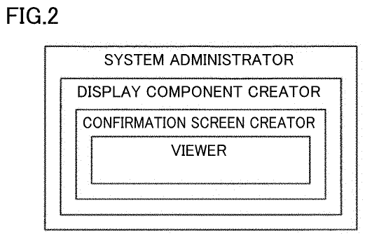

FIG. 2 is a diagram illustrating an example of a type and authority of user in the management system according to the embodiment of the present disclosure.

Referring to FIG. 2, in management system 201, the user is classified into, for example, any one of a system administrator, a display component creator, a confirmation screen creator, and a viewer.

The system administrator, the display component creator, the confirmation screen creator, and the viewer have, in this order, more authority for processing.

More specifically, the viewer can, for example, perform processing of viewing a confirmation screen created by an operation of the confirmation screen creator.

Data visualization apparatus 101 performs processing of displaying the confirmation screen on display 131 in accordance with an operation of the viewer.

The confirmation screen creator can, for example, perform processing of creating the confirmation screen in addition to the processing of viewing the confirmation screen.

Data visualization apparatus 101 creates the confirmation screen on which the display component created by an operation of the display component creator is disposed in accordance with the operation of the confirmation screen creator, and displays the created confirmation screen on display 131.

In addition, the confirmation screen creator can determine whether to allow the viewer to view the created confirmation screen.

Thus, the viewer can view the confirmation screen permitted to be viewed by the confirmation screen creator.

On the other hand, when the confirmation screen creator does not permit the viewer to view the confirmation screen, for example, data visualization apparatus 101 performs processing of displaying a message indicating that the viewer is not permitted to view the confirmation screen on display 131 in response to the operation for viewing the confirmation screen by the viewer.

The display component creator can perform, for example, processing of creating a display component in addition to processing of creating and viewing the confirmation screen.

Data visualization apparatus 101 creates one or more display components constituting the confirmation screen in accordance with an operation of the display component creator.

The display component creator can determine whether to permit the confirmation screen creator to edit the display components created by the display component creator.

Thus, when the display component creator permits the confirmation screen creator to edit the display components, the confirmation screen creator can edit the display components.

The display component creator can determine whether to permit the viewer to view the display components included in the confirmation screen created by the confirmation screen creator.

Data visualization apparatus 101 does not display the display components in the confirmation screen on display 131, for example, when the display component creator does not permit the viewer to view the display components.

The system administrator can perform a user management processing of managing the type of each user in management system 201 in addition to, for example, processing of creating the display components, creating the confirmation screen, and viewing the confirmation screen.

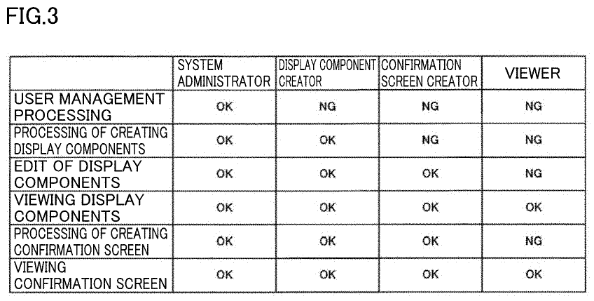

FIG. 3 is a diagram illustrating an example of processing that can be performed for each user type in the management system according to the embodiment of the present disclosure. FIG. 3 illustrates a case where the display component creator permits the confirmation screen creator to edit the display components and the confirmation screen creator permits the viewer to view the confirmation screen.

Referring to FIG. 3, the type of user who can execute the user management processing is the system administrator. The types of user who can execute processing of creating the display components are the system administrator and the display component creator. The types of user who can edit the display components are the system administrator, the display component creator, and the confirmation screen creator. The types of user who can view the display components are the system administrator, the display component creator, the confirmation screen creator, and the viewer. The types of user who can execute processing of creating the confirmation screen are the system administrator, the display component creator, and the confirmation screen creator. The types of user who can view the confirmation screen are the system administrator, the display component creator, the confirmation screen creator, and the viewer.

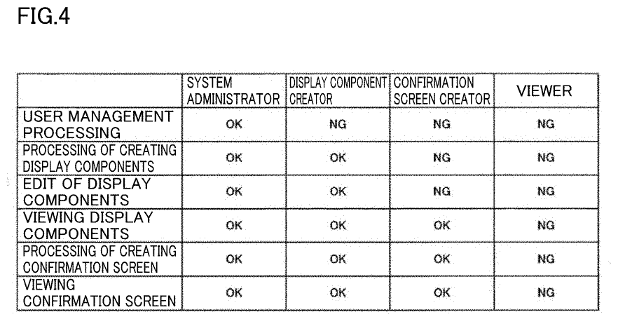

FIG. 4 is a diagram illustrating another example of possible processing for each user type in the management system according to the embodiment of the present disclosure. FIG. 4 illustrates a case where the display component creator does not permit the confirmation screen creator to edit the display components and the confirmation screen creator does not permit the viewer to view the confirmation screen.

Referring to FIG. 4, the type of user who can execute the user management processing is the system administrator. The types of user who can execute processing of creating the display components are the system administrator and the display component creator. The types of user who can edit the display components are the system administrator and the display component creator. The types of user who can view the display components are the system administrator, the display component creator, and the confirmation screen creator. The types of user who can execute processing of creating the confirmation screen are the system administrator, the display component creator, and the confirmation screen creator. The type of users who can view the confirmation screen are the system administrator, the display component creator, and the confirmation screen creator.

Referring again to FIG. 1, authorization unit 15 can set a plurality of types of authority for access processing which is at least one of obtaining measurement data from database 133 or calculation using the measurement data in database 133.

More specifically, data obtaining unit 11 in data visualization apparatus 101 receives the http cookie transmitted from server 132A and outputs the received http cookie to processing unit 14. That is, data obtaining unit 11 obtains the user ID.

Processing unit 14 outputs the http cookie received from data obtaining unit 11 to authorization unit 15.

Authorization unit 15 sets authority for processing performed by processing unit 14 in accordance with the type of user indicated by the http cookie received from processing unit 14.

Specifically, for example, when authorization unit 15 receives an http cookie indicating the confirmation screen creator from processing unit 14, authorization unit 15 limits processing executable by processing unit 14 to processing of displaying the confirmation screen on display 131 and processing of creating the confirmation screen, and outputs restriction information indicating the restricted content to processing unit 14.

When authorization unit 15 receives, for example, an http cookie indicating the display component creator from processing unit 14, authorization unit 15 limits processing executable by processing unit 14 to processing of displaying the confirmation screen on display 131, processing of creating the confirmation screen, and processing of creating the display components, and outputs restriction information indicating the restricted content to processing unit 14.

When authorization unit 15 receives, for example, an http cookie indicating the system administrator from processing unit 14, authorization unit 15 does not limit processing executable by processing unit 14 and outputs restriction information indicating that the restriction is not performed to processing unit 14.

Processing unit 14 receives the restriction information from authorization unit 15 and performs processing of displaying, on display 131, a top screen corresponding to the restriction information, that is, the type of user. For example, the top screen includes a list of display component types and a list of confirmation screen types.

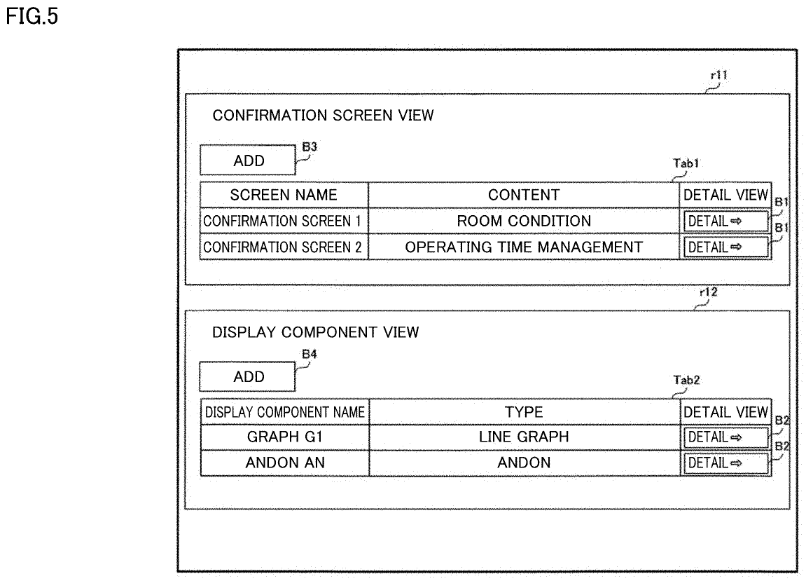

FIG. 5 is a diagram illustrating an example of the top screen displayed on the display in the management system according to the embodiment of the present disclosure. FIG. 5 illustrates the top screen when the type of user is the display component creator.

Referring to FIG. 5, an upper region r11 of the top screen includes a confirmation screen table Tab1 indicating a correspondence between one or more confirmation screens created by confirmation screen creating unit 22 and buttons B1 for displaying the respective confirmation screens on display 131.

A lower region r12 of the top screen includes a display component table Tab2 indicating a correspondence relationship between one or more display components created by display component creating unit 21 and buttons B2 for displaying the respective display components on display 131.

Above confirmation screen table Tab1 in region r11, a button B3 for causing confirmation screen creating unit 22 to create a new confirmation screen is included.

Above display component table Tab2 in region r12, a button B4 for causing display component creating unit 21 to create a new display component is included.

Hyperlinks of URLs corresponding to the respective processing are set in buttons B1 to B4, respectively.

Here, a top screen in the case where the type of user is a confirmation screen creator does not include region r12 corresponding to processing of creating the display component, as compared with the top screen illustrated in FIG. 5, for example.

Further, a top screen in the case where the type of user is a viewer does not include region r12 corresponding to processing of creating the display component and button B3 in region r11, as compared with the top screen illustrated in FIG. 5, for example.

### [Creation of Display Component]

For example, when a user whose type is a display component creator creates, as a display component, a graph G1 based on a target data as an example of content related to measurement data, the user performs an operation of pressing button B4 using a keyboard, a mouse, or the like to data visualization apparatus 101.

Referring again to FIG. 1, when input reception unit 16 receives the operation by the user, for example, input reception unit 16 outputs operation information indicating the content of the operation by the user to processing unit 14.

Processing unit 14 transmits an http request including a URLb for creating the display component to server 132A via data obtaining unit 11, based on the operation information received from input reception unit 16.

Server 132A receives, for example, the http request from data visualization apparatus 101, and based on the received http request, transmits, to data visualization apparatus 101, an http response including an HTML file containing a program (hereinafter also referred to as a creation program) described using JavaScript (registered trademark) or the like for creating the display components.

When processing unit 14 in data visualization apparatus 101 receives the HTML file included in the http response from server 132A via data obtaining unit 11, processing unit 14 obtains the creation program from the received HTML file and executes the obtained creation program.

Thus, display component creating unit 21 creates a new display component.

More specifically, when the creation program is executed by processing unit 14, display component creating unit 21 creates a selection screen for allowing the user to select the type of display component to be created, and outputs the created selection screen to display processing unit 23.

Display processing unit 23 performs processing of displaying the selection screen received from display component creating unit 21 on display 131.

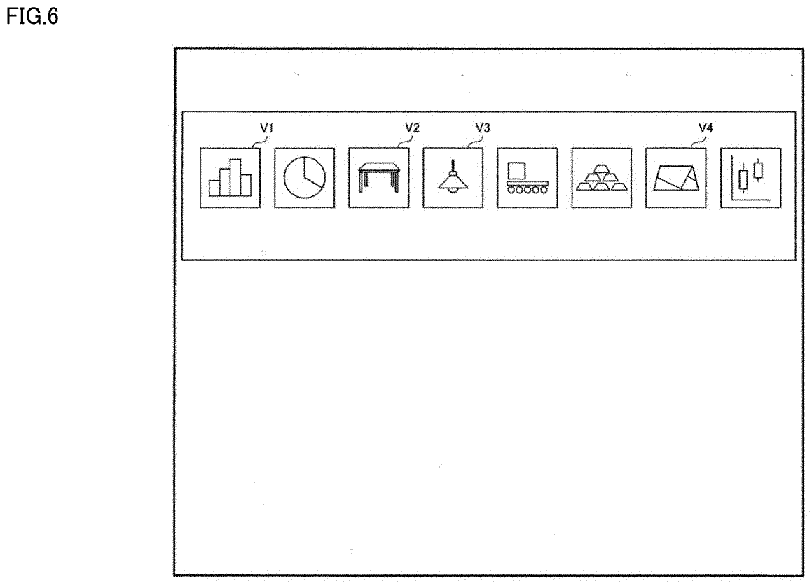

FIG. 6 is a diagram illustrating an example of the selection screen displayed on the display in the management system according to the embodiment of the present disclosure.

Referring to FIG. 6, the selection screen includes a plurality of icons for each type of display components, for example. Specifically, the selection screen includes, for example, an icon V1 for creating a display component such as a bar graph and a line graph, an icon V2 for creating a display component of a table, an icon V3 for creating a display component of Andon, an icon V4 for creating a display component of a map, and the like.

The user can create a desired type of display component by selecting one of the icons on the selection screen.

More specifically, the user can create a display component such as a bar graph and a line graph by selecting icon V1 on the selection screen, for example.

For example, the user performs an operation of selecting icon V1 to data visualization apparatus 101.

For example, when input reception unit 16 receives the operation by the user, input reception unit 16 outputs operation information indicating the content of the operation by the user to display component creating unit 21 in processing unit 14.

Based on the operation information received from input reception unit 16, display component creating unit 21 creates a detailed screen that allows the user to select the type of graph to be created based on the operation information received from input reception section 16, and outputs the created detailed screen to display processing unit 23.

Display processing unit 23 performs processing of displaying the detailed screen received from display component creating unit 21 on display 131.

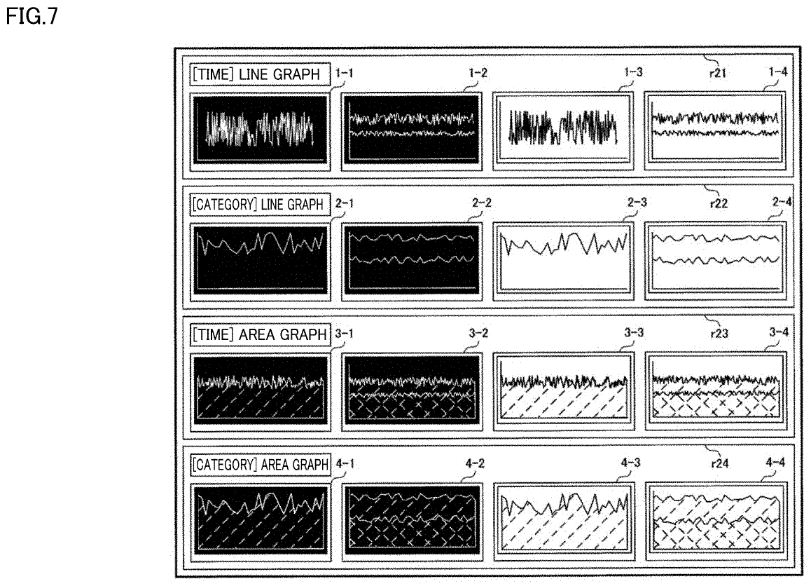

FIG. 7 is a diagram illustrating an example of the detailed screen displayed on the display in the management system according to the embodiment of the present disclosure.

Referring to FIG. 7, the detailed screen includes a region r21 including a plurality of types of line graph 1 whose horizontal axes represent time, a region r22 including a plurality of types of line graph 2 whose horizontal axes represent a category, a region r23 including a plurality of types of area graph 1 whose horizontal axes represent time, and a region r24 including a plurality of types of area graph 2 whose horizontal axes represent a category.

Region r21 includes a type “1-1” in which the background color is black and one line graph 1 is drawn, a type “1-2” in which the background color is black and a plurality of line graphs 1 are drawn, a type “1-3” in which the background color is white and one line graph 1 is drawn, and a type “1-4” in which the background color is white and a plurality of line graphs 1 are drawn.

Region r22 includes a type “2-1” in which the background color is black and one line graph 2 is drawn, a type “2-2” in which the background color is black and a plurality of line graphs 2 are drawn, a type “2-3” in which the background color is white and one line graph 2 is drawn, and a type “2-4” in which the background color is white and a plurality of line graphs 2 are drawn.

Region r23 includes a type “3-1” in which the background color is black and one area graph 1 is drawn, a type “3-2” in which the background color is black and a plurality of area graphs 1 are drawn, a type “3-3” in which the background color is white and one area graph 1 is drawn, and a type “3-4” in which the background color is white and a plurality of area graphs 1 are drawn.

Region r24 includes a type “4-1” in which the background color is black and one area graph 2 is drawn, a type “4-2” in which the background color is black and a plurality of area graphs 2 are drawn, a type “4-3” in which the background color is white and one area graph 2 is drawn, and a type “4-4” in which the background color is white and a plurality of area graphs 2 are drawn.

For example, the user performs an operation of selecting type “1-3” to data visualization apparatus 101.

For example, when input reception unit 16 receives the operation by the user, input reception unit 16 outputs operation information indicating the content of the operation by the user to display component creating unit 21 in processing unit 14.

Based on the operation information received from input reception unit 16, display component creating unit 21 creates an initial setting screen that allows the user to set initial parameters of a graph to be created, and outputs the created initial setting screen to display processing unit 23.

Display processing unit 23 performs processing of displaying the initial setting screen received from display component creating unit 21 on display 131.

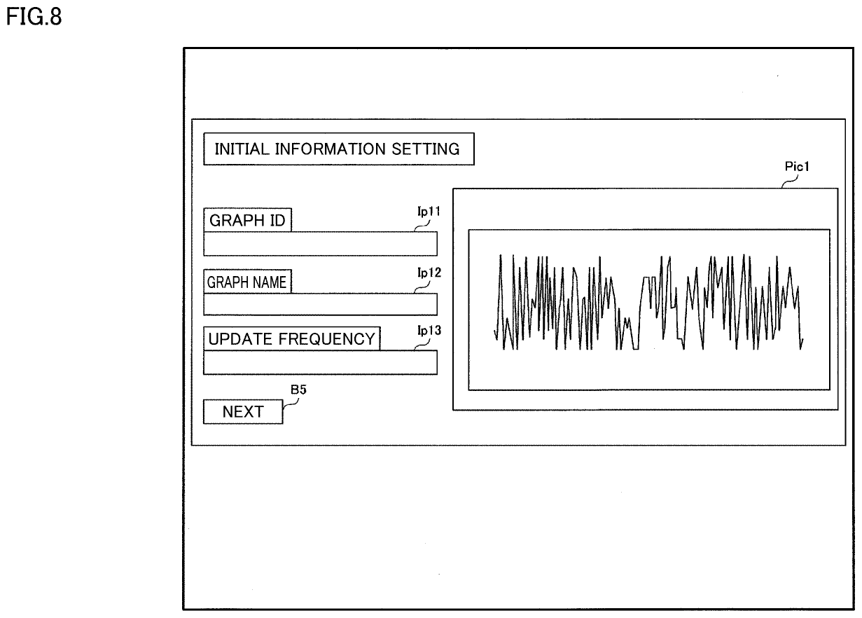

FIG. 8 is a diagram illustrating an example of the initial setting screen that is displayed on the display in the management system according to the embodiment of the present disclosure.

Referring to FIG. 8, the initial setting screen includes, for example, an image Pic1 indicating that a graph to be created is of type “1-3”, input fields Ip11 to Ip13 for inputting “graph ID”, “graph name”, and “update frequency” as initial parameters, respectively, and a button B5 for causing display component creating unit 21 to create the graph.

For example, the user inputs a part or all of “graph ID”, “graph name”, and “update frequency” into the respective input fields, and performs an operation of pressing button B5 to the Web browser.

For example, the user may perform an operation of pressing button B5 to the Web browser without inputting “graph ID”, “graph name”, and “update frequency” into the respective input fields.

Upon receiving the operation by the user, input reception unit 16 outputs the input content of each input field to display component creating unit 21 in processing unit 14.

Here, the creation program includes, for example, an instruction described using SQL (hereinafter also referred to as a temporary SQL instruction) for performing access processing which is at least one of obtaining measurement data from database 133 or calculation using measurement data in database 133.

Display component creating unit 21 creates an http post including the temporary SQL instruction and a URLc for access processing based on the input content received from input reception unit 16, and outputs the created http post to processing unit 14.

Processing unit 14 transmits the http post output from display component creating unit 21 to server 132B via data obtaining unit 11.

Server 132B receives the http post from data visualization apparatus 101 and executes access processing based on the received http post.

Server 132B obtains the temporary SQL instruction included in the received http post, and performs at least one of obtaining measurement data from database 133 or calculation using measurement data in database 133 in accordance with the obtained temporary SQL instruction.

More specifically, for example, when the content of the temporary SQL instruction is an instruction for obtaining measurement data from database 133, server 132B obtains measurement data indicated by the temporary SQL instruction.

For example, when the content of the temporary SQL instruction is an instruction for performing a calculation using measurement data in database 133, server 132B obtains measurement data indicated by the temporary SQL instruction and performs the calculation such as calculation of an average value using the obtained measurement data.

Target data is, for example, a format in accordance with a JavaScript Object Notation (JSON).

Then, server 132B creates an http response including the target data and transmits the http response to data visualization apparatus 101.

Upon receiving the http response from server 132B, data obtaining unit 11 in data visualization apparatus 101 obtains the target data included in the received http response, and outputs the obtained target data to display component creating unit 21 in processing unit 14.

Display component creating unit 21 uses the target data received from data obtaining unit 11 to draw a graph based on the target data as a display component.

More specifically, display component creating unit 21 obtains, for example, an OSS library for drawing a graph of type “1-3” from storage unit 17, and draws graph G1 based on the target data received from data obtaining unit 11 as a display component using the obtained OSS library.

Display component creating unit 21 then creates a component editing screen that includes the drawn graph G1 and a region r3 for editing graph G1, and outputs the created component editing screen to display processing unit 23.

Display processing unit 23 performs processing of displaying the component editing screen received from display component creating unit 21 on display 131.

Display component creating unit 21 can change content of the display component in accordance with one or more parameters.

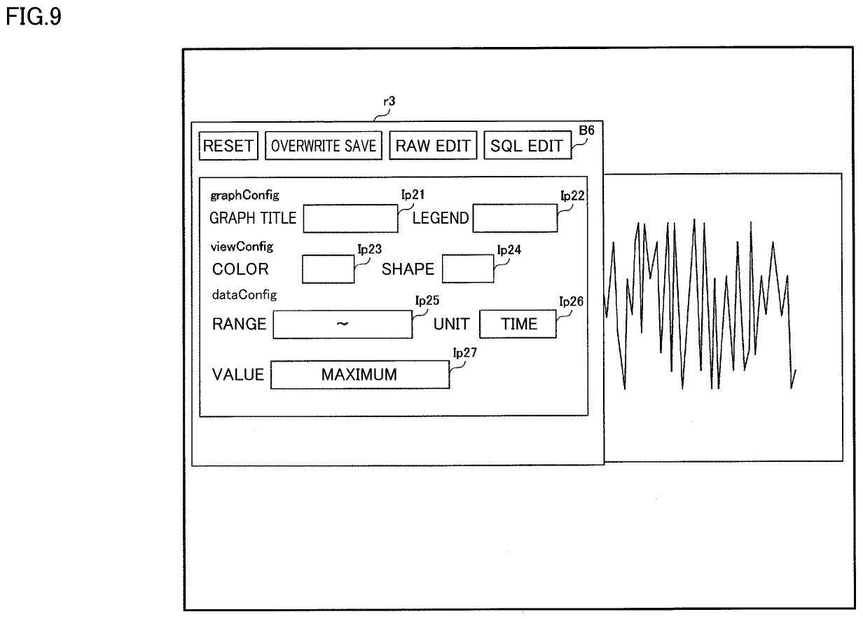

FIG. 9 is a diagram illustrating an example of the component editing screen displayed on the display in the management system according to the embodiment of the present disclosure.

Referring to FIG. 9, on the component editing screen, region r3 is displayed so as to overlap graph G1. Region r3 includes “graphConfig” that includes an input field Ip21 for a graph title and an input field Ip22 for a legend, “viewConfig” that includes an input field Ip23 for a graph color and an input field Ip24 for a shape, and “dataConfig” that includes an input field Ip25 for a temporal range of the graph, an input field Ip26 for an unit of time of the graph, and an input field Ip27 for inputting a type of calculation using measurement data in the graph.

In “graphConfig”, the user can set a graph title and a legend as examples of parameters.

In “dataConfig”, the user can set a graph color and a shape as examples of parameters.

In “viewConfig”, the user can set a temporal range of the graph, a unit of time of the graph, and a type of calculation using measurement data in the graph as examples of parameters.

In addition, a plurality of buttons including a button B6 for editing SQL are displayed in an upper portion of region r3.

When editing SQL, the user performs an operation of pressing button B6 to the Web browser.

For example, when input reception unit 16 receives the operation by the user, input reception unit 16 outputs operation information indicating the content of the operation by the user to display component creating unit 21 in processing unit 14.

Display component creating unit 21 creates a dataConfig screen for editing a temporary SQL instruction based on the operation information received from input reception unit 16, and outputs the created dataConfig screen to display processing unit 23.

Display processing unit 23 performs processing of displaying the dataConfig screen received from display component creating unit 21 on display 131.

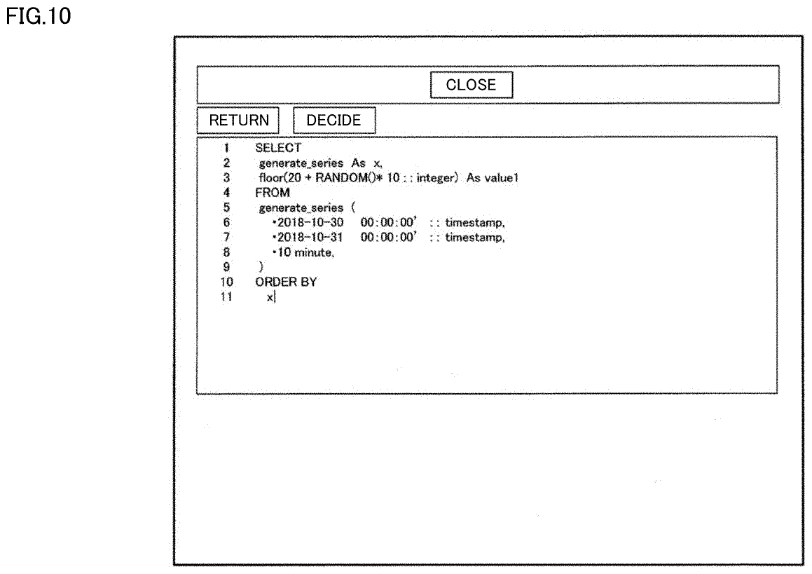

FIG. 10 is a diagram illustrating an example of the dataConfig screen displayed on the display in the management system according to the embodiment of the present disclosure.

Referring to FIG. 10, in the above case, an instruction for performing the access processing, that is, a temporary SQL instruction is displayed on the dataConfig screen.

The user performs an operation of editing the temporary SQL instruction displayed on display 131 to the Web browser using a keyboard or a mouse.

Specifically, the user performs, to the Web browser, an operation of inputting an SQL instruction whose content is to obtain, from database 133, measurement data of a flow rate at a predetermined time interval in a predetermined period measured by a certain sensor, using, for example, the keyboard or the mouse.

Referring again to FIG. 1, for example, upon receiving the operation by the user, input reception unit 16 outputs operation information indicating the content of the operation by the user to display component creating unit 21 in processing unit 14.

Display component creating unit 21 creates a new SQL instruction by updating the temporary SQL instruction based on the operation information received from input reception unit 16. Display component creating unit 21 then creates an http post including the created new SQL instruction and the URLc for access processing, and transmits the created http post to server 132B via data obtaining unit 11. Hereinafter, each of the temporary SQL instruction and the new SQL instruction is also referred to as an SQL instruction.

Server 132B receives the http post from data visualization apparatus 101, obtains the new SQL instruction included in the received http post, and obtains, from database 133, measurement data of a flow rate at the predetermined time interval in the period indicated by the new SQL instruction in accordance with the obtained new SQL instruction.

Server 132B then creates an http response including the obtained measurement data, which is target data, and transmits the http response to data visualization apparatus 101.

Upon receiving the http response from server 132B, data obtaining unit 11 in data visualization apparatus 101 obtains the target data included in the received http response, and outputs the obtained target data to display component creating unit 21 in processing unit 14.

Display component creating unit 21 uses the target data received from data obtaining unit 11 to create a component editing screen including graph G1 based on the target data, and outputs the created component editing screen to display processing unit 23.

Display processing unit 23 performs processing of displaying the component editing screen received from display component creating unit 21 on display 131.

Data visualization apparatus 101 may have a configuration in which the SQL instruction is edited by an operation in which the user inputs, as parameters, the temporal range of graph G1, the unit of time of graph G1, and the type of calculation using the measurement data in graph G1 into the respective input fields Ip25, Ip26, and Ip27 in the dataConfig of the component editing screen illustrated in FIG. 9.

For example, when input reception unit 16 receives the operation by the user, input reception unit 16 outputs input content information indicating input content by the user to display component creating unit 21 in processing unit 14.

Based on the input content information received from input reception unit 16, display component creating unit 21 determines whether it is necessary to edit the SQL instruction in accordance with the change of each of the parameters. When display component creating unit 21 determines that the SQL instruction needs to be changed, display component creating unit 21 edits corresponding parts in the SQL instruction in accordance with the changed parameters.

Authorization unit 15 in data visualization apparatus 101 sets authority based on the content of the SQL instruction. The authority include at least any one of authority that sets the temporal range and the unit of time of measurement data to be obtained from database 133, and authority that sets the type of calculation using the measurement data.

More specifically, display component creating unit 21 outputs the content of the edited SQL instruction to authorization unit 15, for example, when the SQL instruction is edited via the dataConfig screen illustrated in FIG. 10 by a user whose type is the display component creator, or when display component creating unit 21 edits the SQL instruction by the user's input into each of the input fields in the dataConfig of the component editing screen illustrated in FIG. 9.

Based on the content of the SQL instruction received from display component creating unit 21, authorization unit 15 can set a plurality of types of authority for access processing which are at least one of processing of obtaining the measurement data from database 133 or processing of performing calculation using the measurement data in database 133.

For example, authorization unit 15 grants narrower authority to confirmation screen creating unit 22 than to display component creating unit 21.

Specifically, for example, when the content of the SQL instruction received from display component creating unit 21 are content which enable confirmation screen creating unit 22 to set the temporal range and the unit of time of the measurement data to be obtained from database 133, authorization unit 15 outputs, to confirmation screen creating unit 22, authority information indicating that confirmation screen creating unit 22 has the authority to make such a setting.

Accordingly, a user whose type is a confirmation screen creator can set the temporal range and the unit of time of the measurement data to be obtained from database 133 in processing of creating the confirmation screen.

Also, for example, authorization unit 15 grants narrower authority to display processing unit 23 than to confirmation screen creating unit 22.

Specifically, for example, when the content of the SQL instruction received from display component creating unit 21 are content which enable display processing unit 23 to set the temporal range of the measurement data to be obtained from database 133, authorization unit 15 outputs, to display processing unit 23, authority information indicating that display processing unit 23 has the authority to make such a setting.

Accordingly, a user whose type is a viewer can set the temporal range of the display component disposed on the confirmation screen created by a user whose type is the confirmation screen creator.

For example, when a user whose type is a display component creator edits a graph title and a legend as parameters, the user performs, to the Web browser, an operation of inputting a new graph title and a new legend into input fields Ip21 and Ip22 on the component editing screen illustrated in FIG. 9.

Referring again to FIG. 1, for example, upon receiving the operation by the user, input reception unit 16 outputs operation information indicating the content of the operation by the user to display component creating unit 21 in processing unit 14.

Based on the operation information received from input reception unit 16, display component creating unit 21 creates a component editing screen including graph G1 in which a new graph title and a legend are set, and outputs the created component editing screen to display processing unit 23.

Display processing unit 23 performs processing of displaying the component editing screen received from display component creating unit 21 on display 131.

For example, when editing a graph color and a shape as parameters, the user performs, to the Web browser, an operation of inputting a new graph color and a new shape into input fields Ip23 and Ip24, respectively, on the component editing screen illustrated in FIG. 9.

For example, when input reception unit 16 receives the operation by the user, input reception unit 16 outputs operation information indicating the content of the operation by the user to display component creating unit 21 in processing unit 14.

Based on the operation information received from input reception unit 16, display component creating unit 21 creates a component editing screen including graph G1 in which the new graph color and the shape are set, and outputs the created component editing screen to display processing unit 23.

Display processing unit 23 performs processing of displaying the component editing screen received from display component creating unit 21 on display 131.

Thereafter, display component creating unit 21 transmits an http post including the SQL instruction and the URLc for access processing to server 132B at each time interval set in “update frequency” on the initial setting screen illustrated in FIG. 8.

Accordingly, display component creating unit 21 obtains new target data from database 133 via server 132B and data obtaining unit 11 at each time interval set in the “update frequency”, and uses the obtained target data to update the display component such as graph G1 based on the target data.

Display component creating unit 21 stores the created display component in storage unit 17 in accordance with, for example, an operation by the user.

More specifically, for example, the user performs, to the Web browser, an operation of pressing an “overwrite save” button for saving the created display component among a plurality of buttons on the component editing screen illustrated in FIG. 9.

For example, when input reception unit 16 receives the operation by the user, input reception unit 16 outputs operation information indicating the content of the operation by the user to display component creating unit 21 in processing unit 14.

Display component creating unit 21 stores display component information including the created SQL instruction and the content of the set parameters in storage unit 17, based on the operation information received from input reception unit 16.

Thus, the new display component created by display component creating unit 21 and button B2 for displaying the display component on display 131 are added to display component table Tab2 on the top screen illustrated in FIG. 5.

### [Update of Display Component]

For example, a user whose type is a display component creator performs, to the Web browser, an operation of pressing button B2 corresponding to graph G1 on the top screen illustrated in FIG. 5 using a keyboard, a mouse, or the like.

Referring again to FIG. 1, when input reception unit 16 receives the operation by the user, for example, input reception unit 16 outputs operation information indicating the content of the operation by the user to processing unit 14.

Processing unit 14 transmits an http request including the URLb for creating a display component to server 132A via data obtaining unit 11 based on the operation information received from input reception unit 16.

Upon receiving the http request from data visualization apparatus 101, server 132A transmits an http response including an HTML file storing a creation program to data visualization apparatus 101 based on the received http request.

When processing unit 14 in data visualization apparatus 101 receives the HTML file included in the http response from server 132A via data obtaining unit 11, processing unit 14 obtains the creation program from the received HTML file.

Processing unit 14 obtains display component information corresponding to graph G1 from storage unit 17 based on the operation information received from input reception unit 16. Processing unit 14 then executes the creation program in which the temporary SQL instruction in the obtained creation program is changed to the SQL instruction included in the obtained display component information.

As a result, the component editing screen including graph G1 corresponding to the display component information is displayed on display 131.

In data visualization apparatus 101, the display component is not limited to graph G1, and may be a different type of graph, table, Andon, process management table, Gantt chart, map information, box plot, or the like.

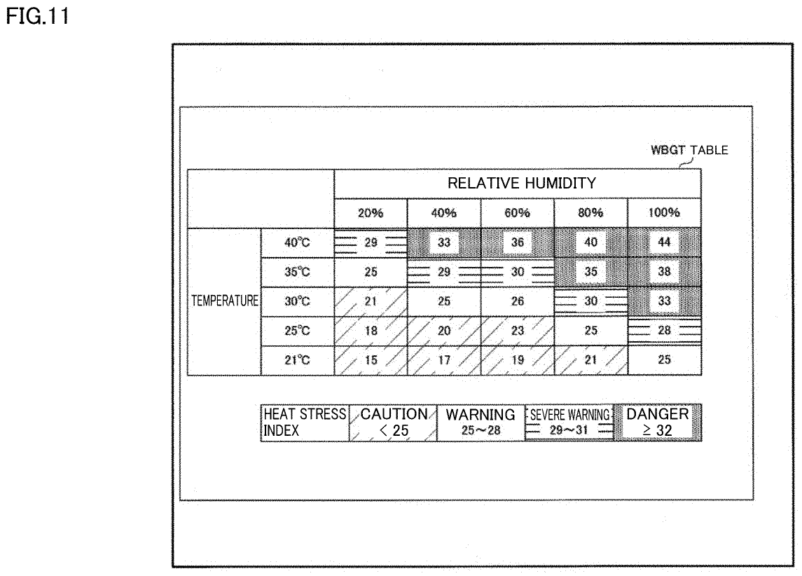

FIG. 11 is a diagram illustrating an example of the display component in the management system according to the embodiment of the present disclosure.

FIG. 11 illustrates a WBGT (Wet Bulb Globe Temperature) table as an example of the display component.

Referring to FIG. 11, the WBGT table indicates a correspondence of temperature and relative humidity to heat stress index calculated based on the temperature and the relative humidity.

In the WBGT table, different colors are used in accordance with a value of the heat stress index. Specifically, the color for a heat stress index less than 25, the color for a heat stress index of 25 to 28, the color for a heat stress index of 29 to 31, and the color for a heat stress index of 32 or more are different from each other. In FIG. 11, different colors are indicated by different hatchings.

For example, a class of the heat stress index illustrated in the WBGT table is displayed below the WBGT table. Specifically, the class for a heat stress index of less than 25 represents “Caution”, the class for a heat stress index of 25 to 28 represents “Warning”, the class for a heat stress index of 29 to 31 represents “Severe Warning”, and the class for a heat stress index of 32 or more represents “Danger”.

For example, when creating the WBGT table, a user selects icon V2 on the selection screen illustrated in FIG. 6.

Then, the user creates the WBGT table, for example, by performing an operation to data visualization apparatus 101 in accordance with the screen displayed on display 131.

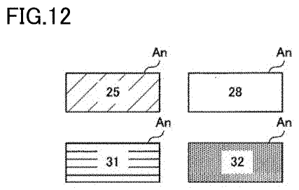

FIG. 12 is a diagram illustrating an example of the display component in the management system according to the embodiment of the present disclosure. FIG. 12 illustrates a plurality of Andons An as an example of the display component. Andon is a display method of notifying a user of a warning in accordance with displayed colors.

Referring to FIG. 12, Andons An indicate, for example, heat stress indices illustrated in the WBGT table. The colors of Andons An are colors corresponding to heat stress indices in accordance with the WBGT table, for example. In FIG. 12, different colors are represented by different hatchings.

For example, when creating Andons, a user selects icon V3 on the selection screen illustrated in FIG. 6.

For example, the user then creates Andons by performing an operation to data visualization apparatus 101 in accordance with a screen displayed on display 131.

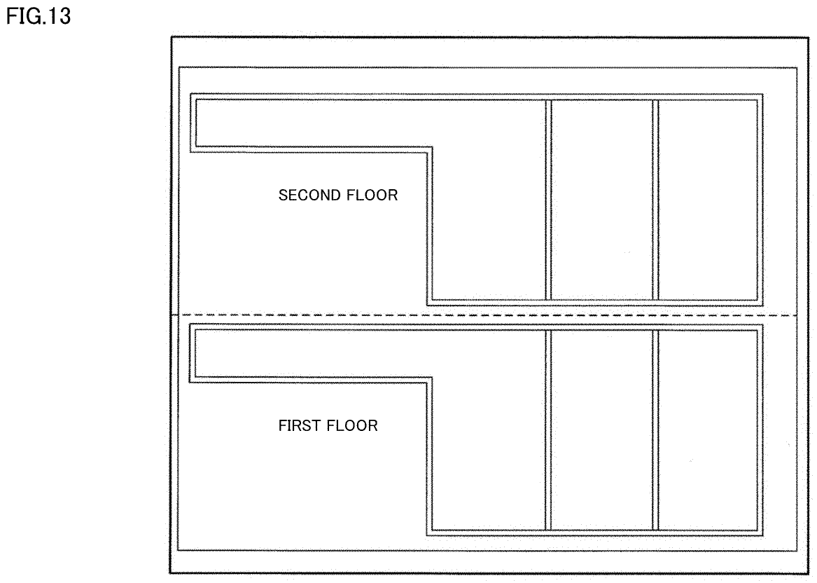

FIG. 13 is a diagram illustrating an example of the display component in the management system according to the embodiment of the present disclosure. FIG. 13 illustrates map information as an example of the display component.

Referring to FIG. 13, the map information indicates, for example, a floor plan of a two storied factory to be managed by management system 201.

When creating the map information, for example, a user selects icon V4 on the selection screen illustrated in FIG. 6.

For example, the user then creates the map information by performing an operation to data visualization apparatus 101 in accordance with a screen displayed on display 131.

### [Creation of Confirmation Screen]

A user whose type is a confirmation screen creator or a display component creator, for example, performs, to data visualization apparatus 101, an operation of pressing button B3 on the top screen illustrated in FIG. 5 using a keyboard, a mouse, or the like.

Referring again to FIG. 1, when input reception unit 16 receives the operation by the user, for example, input reception unit 16 outputs operation information indicating the content of the operation by the user to processing unit 14.

Based on the operation information received from input reception unit 16, processing unit 14 transmits an http request including the URLd for creating a confirmation screen to server 132A via data obtaining unit 11.

When the http request is received from data visualization apparatus 101, server 132A transmits to data visualization apparatus 101, based on the received http request, an http response including an HTML file containing a program (hereinafter also referred to as a display program) described using JavaScript (registered trademark) or the like for displaying the confirmation screen.

When processing unit 14 in data visualization apparatus 101 receives the HTML file included in the http response from server 132A via data obtaining unit 11, processing unit 14 obtains the display program from the received HTML file and executes the obtained display program.

Accordingly, confirmation screen creating unit 22 creates the confirmation screen in which one or more display components created by display component creating unit 21 are disposed.

More specifically, when the display program is executed by processing unit 14, confirmation screen creating unit 22 creates a layout screen for disposing the display components, and outputs the created layout screen to display processing unit 23.

Display processing unit 23 performs processing of displaying the layout screen received from confirmation screen creating unit 22 on display 131.

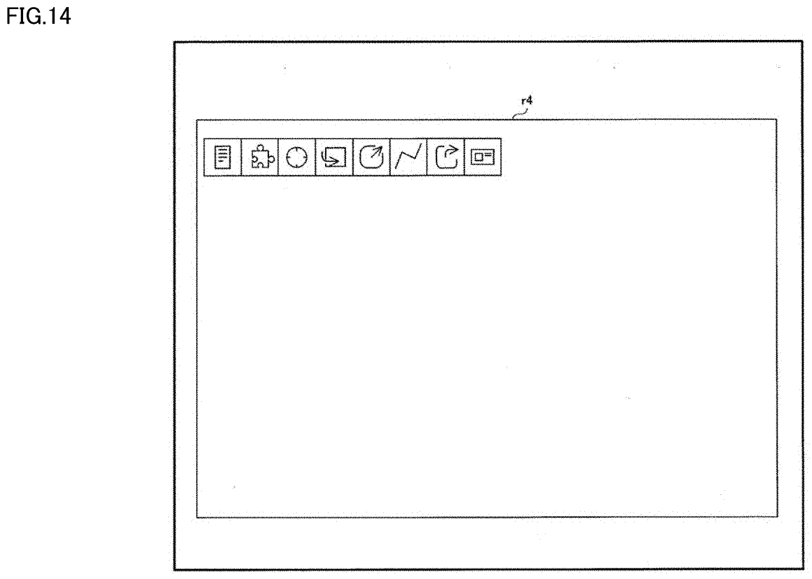

FIG. 14 is a diagram illustrating an example of the layout screen displayed on the display in the management system according to the embodiment of the present disclosure.

Referring to FIG. 14, the layout screen includes a region r4 in which a display component is to be disposed. A plurality of buttons for selecting the display component to be disposed are included in an upper part of region r4.

The user performs an operation of pressing a button corresponding to the display component to be disposed among the plurality of buttons to the Web browser. Then, the user performs, to the Web browser, an operation of selecting a position where the display component is to be disposed in region r4.

For example, when receiving the operation by the user, input reception unit 16 outputs operation information indicating the content of the operation by the user to confirmation screen creating unit 22 in processing unit 14.

Confirmation screen creating unit 22 disposes the display component in region r4 in accordance with the operation information received from input reception unit 16.

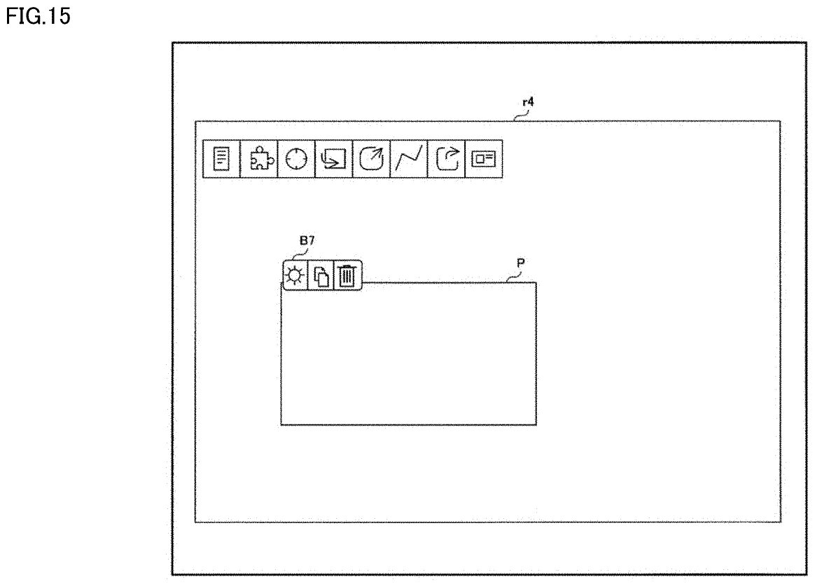

FIG. 15 is a diagram illustrating an example of a screen in which a display component is disposed on a layout screen in the management system according to the embodiment of the present disclosure.

Referring to FIG. 15, the display component is disposed at a position P in region r4. The display component includes a button B7 for selecting content of the display component.

Confirmation screen creating unit 22 can select the content of the display component in the confirmation screen by setting one or more parameters in accordance with an instruction from the user.

For example, the user performs an operation of pressing button B7 to the Web browser.

For example, when receiving the operation by the user, input reception unit 16 outputs operation information indicating the content of the operation by the user to confirmation screen creating unit 22 in processing unit 14.

Based on the operation information received from input reception unit 16, confirmation screen creating unit 22 creates a content selection screen including a table Tab3 indicating display components created by display component creating unit 21, and outputs the created content selection screen to display processing unit 23.

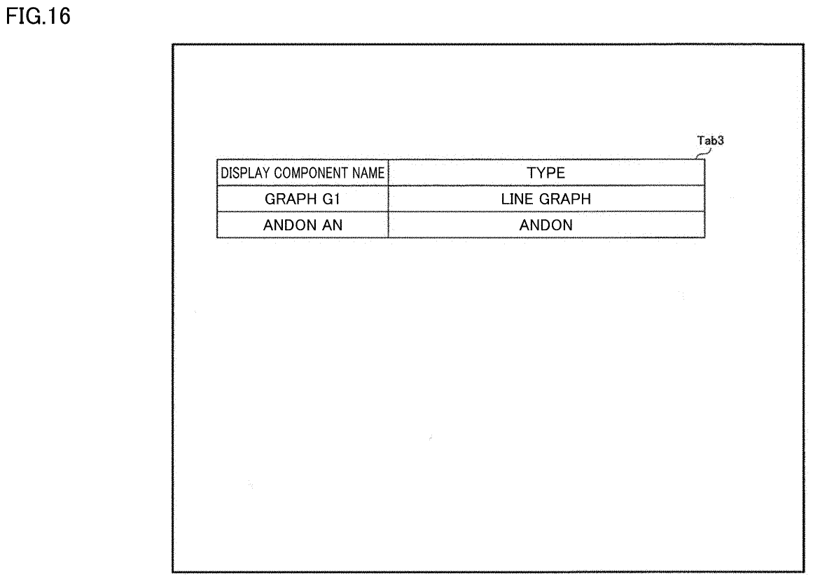

FIG. 16 is a diagram illustrating an example of the content selection screen displayed on the display in the management system according to the embodiment of the present disclosure.

Referring to FIG. 16, table Tab3 illustrates a correspondence between one or more display components created by display component creating unit 21 and types of the display components.

Display processing unit 23 performs processing of displaying the content selection screen received from confirmation screen creating unit 22 on display 131.

The user performs, to the Web browser, an operation of selecting one display component, for example, graph G1 from table Tab3 on the content selection screen.

For example, upon receiving the operation by the user, input reception unit 16 outputs operation information indicating the content of the operation by the user to confirmation screen creating unit 22 in processing unit 14.

Confirmation screen creating unit 22 obtains a SQL instruction included in the display component information corresponding to graph G1 from storage unit 17 based on the operation information received from input reception unit 16.

Then, confirmation screen creating unit 22 creates an http post including the obtained SQL instruction and the URLc for access processing, and transmits the created http post to server 132B via data obtaining unit 11.

Upon receiving the http post from data visualization apparatus 101, server 132B obtains the SQL instruction included in the received http post, and performs at least one of processing of obtaining measurement data from database 133 or processing of calculation using the measurement data in database 133 in accordance with the obtained SQL instruction.

Then, server 132B creates an http response including target data which is at least one of the obtained measurement data or the calculation result of calculation using the measurement data, and transmits the http response to data visualization apparatus 101.

Upon receiving the http response from server 132B, data obtaining unit 11 in data visualization apparatus 101 obtains the target data included in the received http response, and outputs the obtained target data to confirmation screen creating unit 22 in processing unit 14.

Confirmation screen creating unit 22 then obtains, for example, an OSS library for drawing graph G1 from storage unit 17, and draws graph G1 based on the target data received from data obtaining unit 11 in the display component disposed on the layout screen using the obtained OSS library.

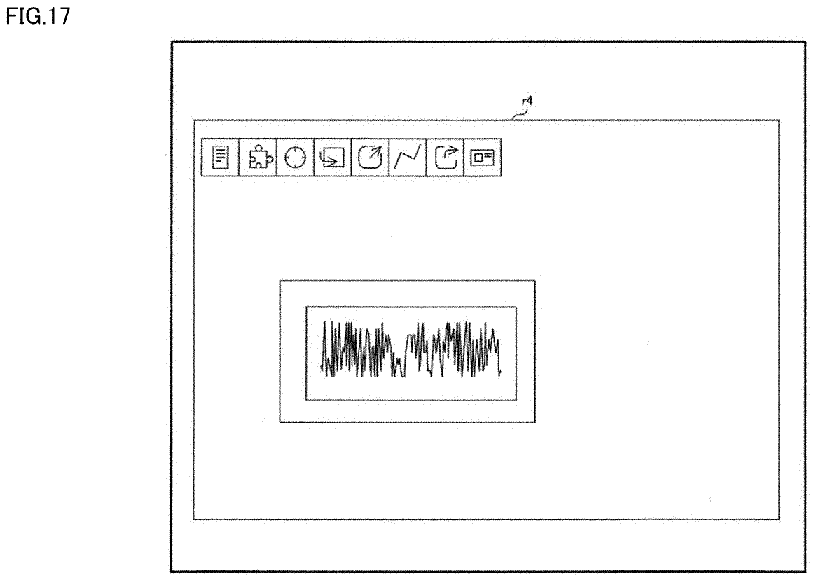

FIG. 17 is a diagram illustrating an example of a screen on which a display component is disposed in the layout screen in the management system according to the embodiment of the present disclosure.

Referring to FIG. 17, graph G1 is disposed as a display component at position P illustrated in FIG. 15.

Confirmation screen creating unit 22 can dispose a plurality of display components on the layout screen by setting one or more parameters of the display components, for example.

More specifically, the user can create a layout screen in which one or more desired display components are disposed by repeatedly performing the above-described operation.

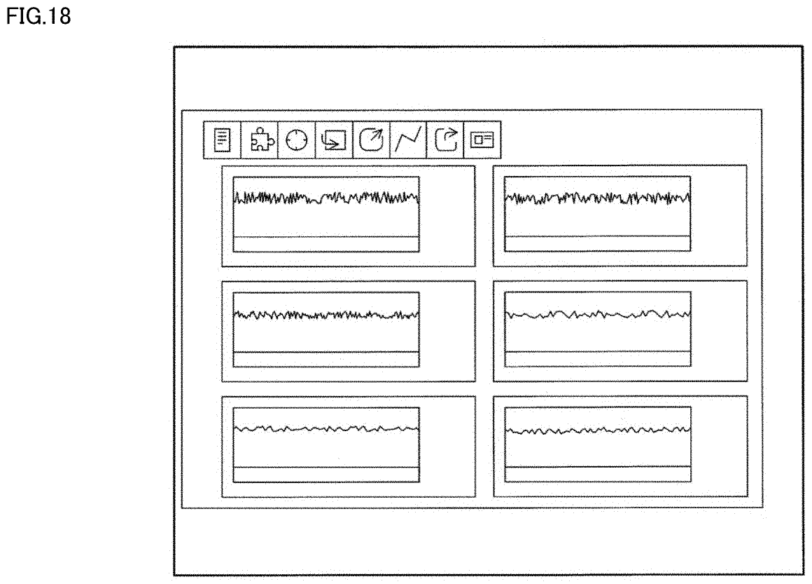

FIG. 18 is a diagram illustrating an example of a layout screen in which a plurality of display components are disposed in the management system according to the embodiment of the present disclosure.

Referring to FIG. 18, a plurality of graphs G1 having one or more different parameters are disposed in region r4 of the layout screen.

For example, the user selects any one of the plurality of graphs G1 and performs an operation of changing a parameter of the selected graph G1 to the Web browser.

For example, upon receiving the operation by the user, input reception unit 16 outputs operation information indicating the content of the operation by the user to confirmation screen creating unit 22 in processing unit 14.

Confirmation screen creating unit 22 creates a parameter setting screen for changing parameters of graph G1 based on the operation information received from input reception unit 16, and outputs the created parameter setting screen to display processing unit 23.

Display processing unit 23 performs processing of displaying the parameter setting screen received from display component creating unit 21 on display 131.

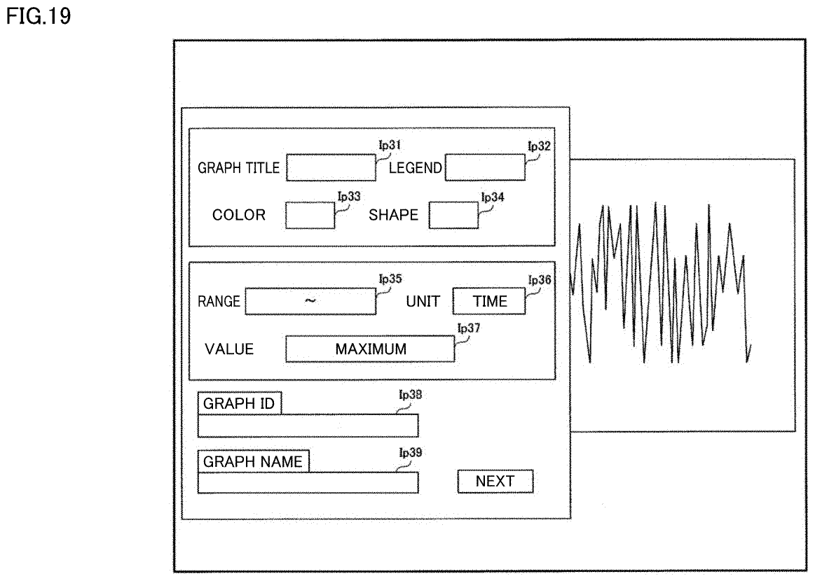

FIG. 19 is a diagram illustrating an example of the parameter setting screen in the management system according to the embodiment of the present disclosure.

Referring to FIG. 19, the parameter setting screen includes an input field Ip31 for a graph title, an input field Ip32 for a legend, an input field Ip33 for a graph color, and an input field Ip34 for a shape.

The parameter setting screen includes, for example, an input field Ip35 for a temporal range of graph G1, an input field Ip36 for a unit of time of graph G1, and an input field Ip37 for inputting the type of calculation using measurement data in graph G1.

The parameter setting screen includes an input field Ip38 for a graph ID of graph Gland an input field Ip39 for a graph name of graph G1.

Also, confirmation screen creating unit 22 limits the types of parameters that can be set on the parameter setting screen based on authority information received from authorization unit 15 described above.

Thus, confirmation screen creating unit 22 is granted narrower authority than display component creating unit 21 by authorization unit 15.

More specifically, confirmation screen creating unit 22 creates a parameter setting screen in which the input of input field Ip35 is limited, for example, in a case where the authority information having content for limiting the temporal range of measurement data to be obtained from database 133 is received from authorization unit 15.

That is, confirmation screen creating unit 22 is limited in authority for access processing.

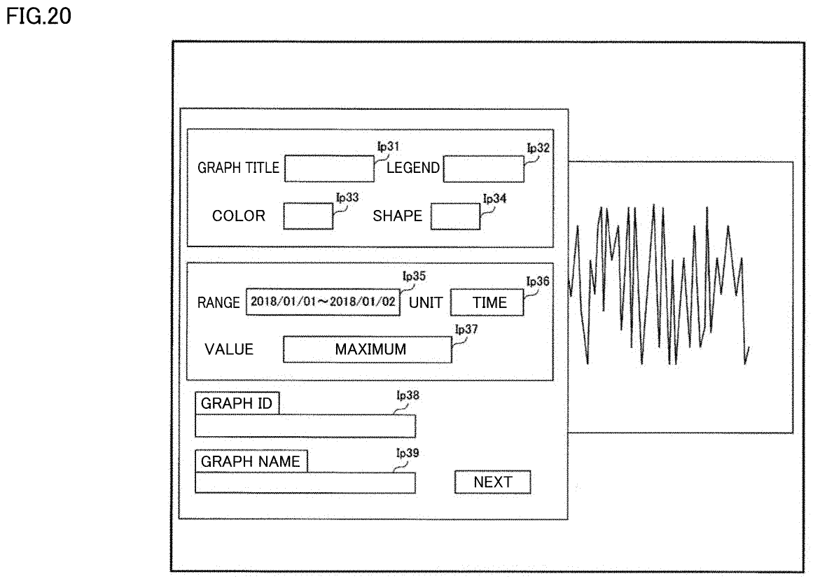

FIG. 20 is a diagram illustrating another example of the parameter setting screen in the management system according to the embodiment of the present disclosure.

Referring to FIG. 20, in the parameter setting screen in the state where the authority for access processing is limited, for example, a fixed value is displayed in input field Ip35, as compared with the parameter setting screen illustrated in FIG. 19.

The parameter setting screen in the state in which the authority for access processing is limited is not limited to the display of the fixed value in input field Ip35, and input field Ip35 may not be displayed.

Referring again to FIGS. 1 and 19, when input reception unit 16 receives, for example, an operation of changing a parameter by a user, input reception unit 16 outputs operation information indicating the content of the operation by the user to confirmation screen creating unit 22 in processing unit 14.

Confirmation screen creating unit 22 obtains a SQL instruction included in the corresponding display component information from storage unit 17 based on the operation information received from input reception unit 16, and edits the corresponding parts in the SQL instruction in accordance with the changed parameters.

Confirmation screen creating unit 22 then creates an http post including the edited SQL instruction and the URLc for access processing, and transmits the created http post to server 132B via data obtaining unit 11.

Server 132B receives the http post from data visualization apparatus 101, obtains the SQL instruction included in the received http post, and performs at least one of processing of obtaining measurement data from database 133 or processing of calculation using the measurement data in database 133 in accordance with the obtained SQL instruction.

Server 132B then creates an http response including target data which is at least one of the obtained measurement data or the calculation result of calculation using the measurement data, and transmits the http response to data visualization apparatus 101.

Upon receiving the http response from server 132B, data obtaining unit 11 in data visualization apparatus 101 obtains the target data included in the received http response, and outputs the obtained target data to confirmation screen creating unit 22 in processing unit 14.

Then, confirmation screen creating unit 22 obtains, for example, an OSS library for drawing graph G1 from storage unit 17, and draws graph G1 based on the target data received from data obtaining unit 11 in the display component disposed in the layout screen by using the obtained OSS library.

Further, confirmation screen creating unit 22 stores the created confirmation screen in storage unit 17 in accordance with, for example, an operation by a user.

More specifically, for example, in the layout screen illustrated in FIG. 18, the user performs an operation for saving the layout screen to the Web browser.

For example, when receiving the operation by the user, input reception unit 16 outputs operation information indicating the content of the operation by the user to confirmation screen creating unit 22 in processing unit 14.

Based on the operation information received from input reception unit 16, confirmation screen creating unit 22 stores, in storage unit 17, confirmation screen information including each of the content of the SQL instruction and the set parameters of one or more display components included in the layout screen.

Thus, the new confirmation screen created by confirmation screen creating unit 22 and button B1 for displaying the confirmation screen on display 131 are added to confirmation screen table Tab1 on the top screen illustrated in FIG. 5. Thus, confirmation screen creating unit 22 can create a plurality of confirmation screens.

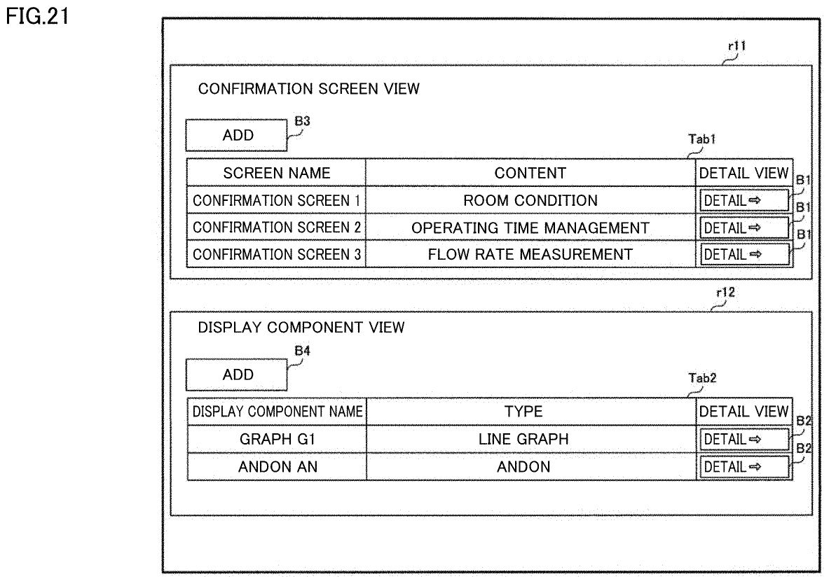

FIG. 21 is a diagram illustrating another example of a top screen displayed on a display in the management system according to the embodiment of the present disclosure.

FIG. 21 illustrates a top screen after a “confirmation screen 3” is created by confirmation screen creating unit 22, for example.

Referring to FIG. 21, compared to the top screen illustrated in FIG. 5, confirmation screen 3 newly created by confirmation screen creating unit 22 and button B1 for displaying confirmation screen 3 on display 131 are added to confirmation screen table Tab1 on the top screen.

In a state where data visualization apparatus 101 has already created a plurality of display components and a plurality of confirmation screens, data visualization apparatus 101 can change content of the plurality of display components included in the confirmation screens for each confirmation screen by updating the display components in accordance with an instruction from a user.

More specifically, display component creating unit 21 updates “graph G1” illustrated in FIG. 21, for example, in accordance with an operation by a user to update “graph G1”, and stores, in storage unit 17, display component information including content of parameters corresponding to the updated “graph G1”.

Thus, in data visualization apparatus 101, for example, content of a plurality of “graphs G1” included in “confirmation screen 3” can be changed at a time.

### [Viewing of Confirmation Screen]

A user whose type is a viewer, a confirmation screen creator, or a display component creator performs, for example, an operation of pressing button B1 corresponding to “confirmation screen 1” on the top screen illustrated in FIG. 5 using a keyboard, a mouse, or the like to the Web browser.

Referring again to FIG. 1, when input reception unit 16 receives the operation by the user, for example, input reception unit 16 outputs operation information indicating the content of the operation by the user to processing unit 14.

Based on the operation information received from input reception unit 16, processing unit 14 transmits an http request including the URLd for creating a confirmation screen to server 132A via data obtaining unit 11 based on the operation information received from input reception unit 16.

Upon receiving the http request from data visualization apparatus 101, server 132A transmits an http response including an HTML file storing a display program to data visualization apparatus 101 based on the received http request.

When processing unit 14 in data visualization apparatus 101 receives the HTML file included in the http response from server 132A via data obtaining unit 11, processing unit 14 obtains the display program from the received HTML file.

Processing unit 14 also obtains confirmation screen information corresponding to “confirmation screen 1” from storage unit 17 based on the operation information received from input reception unit 16. Then, processing unit 14 reflects the obtained confirmation screen information on the obtained display program and executes the display program.

As a result, a layout screen corresponding to the confirmation screen information is displayed on display 131.

Further, for example, confirmation screen creating unit 22 can create a confirmation screen in which a plurality of types of display components are disposed by setting one or more parameters, based on authority set by a user's operation and authorization unit 15.

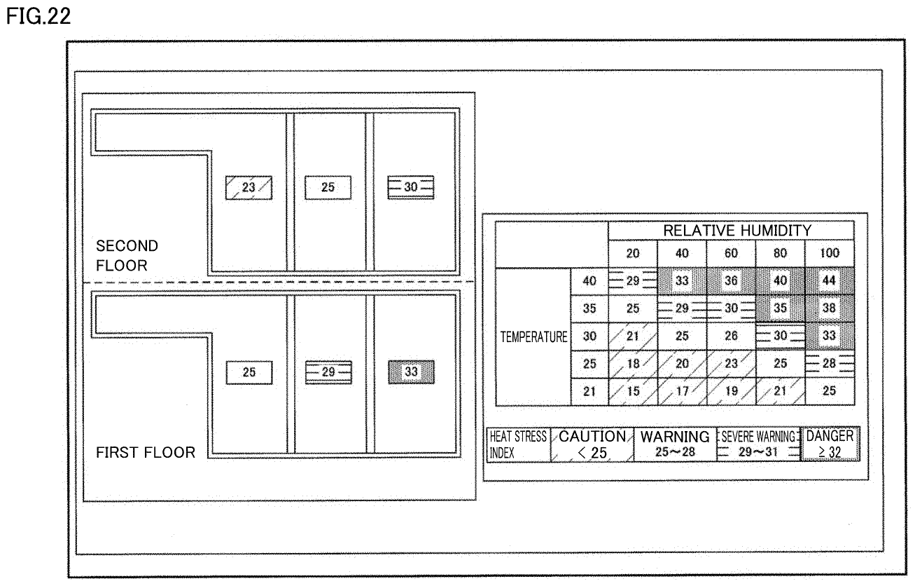

FIG. 22 is a diagram illustrating an example of a layout screen in which a plurality of types of display components are disposed in the management system according to the embodiment of the present disclosure.

Referring to FIG. 22, the layout screen includes, for example, the WBGT table illustrated in FIG. 11, the Andons An illustrated in FIG. 12, and the map information illustrated in FIG. 13.

In the layout screen, heat stress indices at a plurality of locations in the two storied factory are indicated using Andons An.

The user can check heat stress indices and classes of the heat stress indices at the plurality of locations in the two storied factory by using the layout screen, for example.

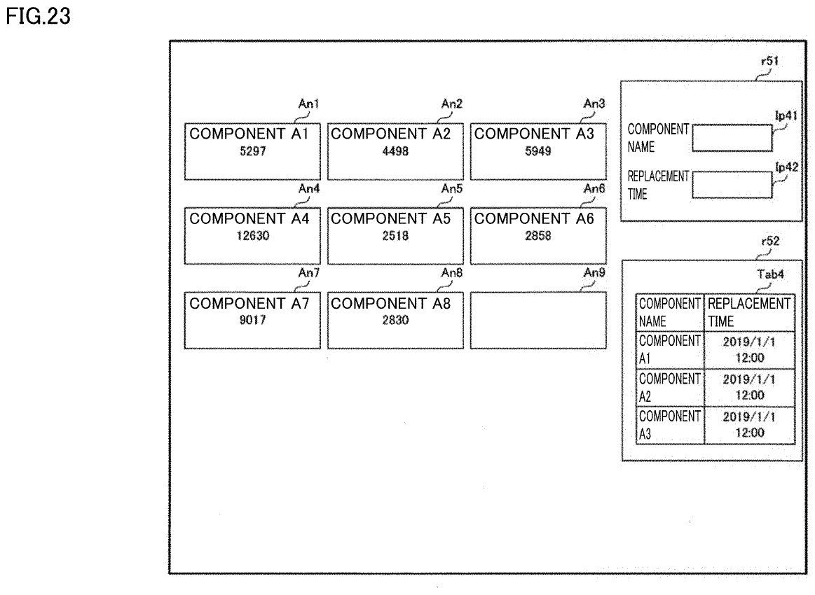

FIG. 23 is a diagram illustrating an example of a layout screen in which a plurality of types of display components are disposed in the management system according to the embodiment of the present disclosure.

The layout screen illustrated in FIG. 23 is used, for example, to manage operating time of a plurality of components.

Referring to FIG. 23, the layout screen includes Andons An1 to An9 created by display component creating unit 21.

Andon An1 indicates that an operating time of a component A1 is 5297 hours. Andon An2 indicates that an operating time of a component A2 is 4498 hours. Andon An2 indicates that an operating time of a component A3 is 5949 hours. Andon An4 indicates that an operating time of a component A4 is 12630 hours. Andon An5 indicates that an operating time of a component A5 is 2518 hours. Andon An6 indicates that an operating time of a component A6 is 2858 hours. Andon An7 indicates that an operating time of a component A7 is 9017 hours. Andon An8 indicates that an operating time of a component A8 is 2830 hours. Andon An9 is an unset Andon.

In addition, a region r51 on the upper right side of Andons An1 to An9 in the layout screen includes an input field Ip41 for a component name and an input field Ip42 for an operation start time of the component as parameters of each of the Andons.

In addition, a region r52 on the lower right side of Andons An1 to An9 in the layout screen includes a table Tab4 indicating a correspondence between component name and replacement time of each of the components.

Referring again to FIG. 1, when input reception unit 16 receives, for example, an operation of inputting the component name into input field Ip41 and an operation of inputting the operation start time of the component into input field Ip42 by a user, input reception unit 16 outputs operation information indicating contents of the operations by the user to confirmation screen creating unit 22 in processing unit 14.

Confirmation screen creating unit 22 obtains a SQL instruction included in display component information corresponding to the component name inputted by the user from storage unit 17 based on the operation information received from input reception unit 16, and edits a part corresponding to the operation start time in the obtained SQL instruction to the operation start time inputted by the user.

Then, confirmation screen creating unit 22 creates an http post including the edited SQL instruction and the URLc for access processing, and transmits the created http post to server 132B via data obtaining unit 11.

Server 132B receives the http post from data visualization apparatus 101, obtains the SQL instruction included in the received http post, and calculates an operating time of the corresponding component by subtracting the operation start time indicated by the SQL instruction from the current time in accordance with the obtained SQL instruction.

Then, server 132B creates an http response including the operating time calculated as target data and transmits the http response to data visualization apparatus 101.

Upon receiving the http response from server 132B, data obtaining unit 11 in data visualization apparatus 101 obtains the target data included in the received http response, and outputs the obtained target data to confirmation screen creating unit 22 in processing unit 14.

Then, confirmation screen creating unit 22 obtains, for example, an OSS library for drawing Andon An from storage unit 17, and draws Andon An based on the target data received from data obtaining unit 11 on a display component disposed on the layout screen using the obtained OSS library.

In addition, confirmation screen creating unit 22 obtains, for example, an OSS library for drawing a table from storage unit 17, and draws a table Tab4 based on the target data received from data obtaining unit 11 on a display component disposed on the layout screen using the obtained OSS library.

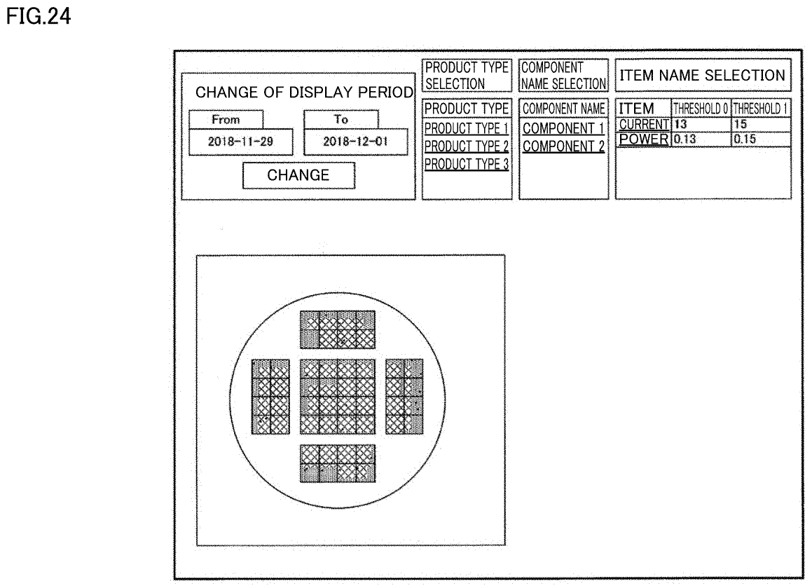

FIG. 24 is a diagram illustrating an example of a layout screen in which a plurality of types of display components are disposed in the management system according to the embodiment of the present disclosure.

The layout screen illustrated in FIG. 24 is used, for example, to check current or power values in a plurality of types of products and components in a certain period of time.

Referring to FIG. 24, the upper part of the layout screen includes, in order from left to right, a input field for a display period, a table created by display component creating unit 21 for selecting a product type, a table created by display component creating unit 21 for selecting a component name, and a table created by display component creating unit 21 for selecting an item to be displayed.

The lower part of the layout screen includes an image indicating information corresponding to the selected product type, component name, and item.

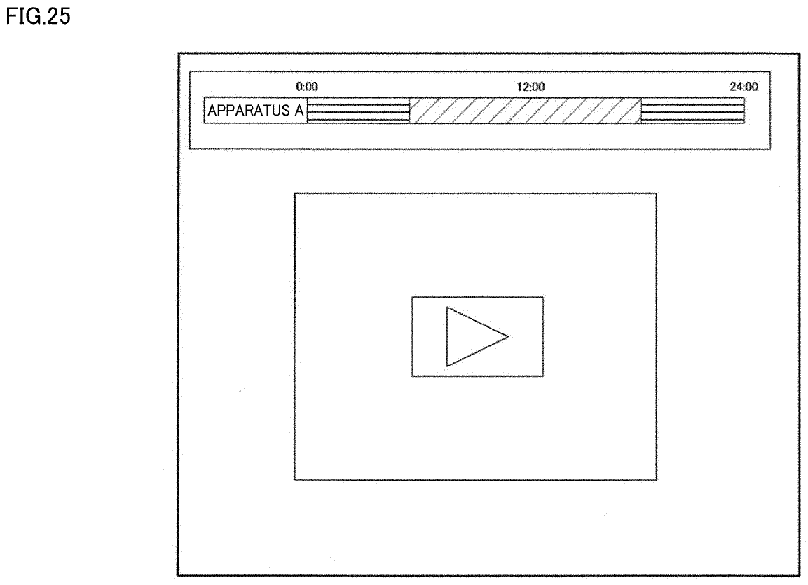

FIG. 25 is a diagram illustrating an example of a layout screen in which a plurality of types of display components are disposed in the management system according to the embodiment of the present disclosure.

The layout screen illustrated in FIG. 25 is used, for example, for a user to confirm a state of a certain device using a video.

Referring to FIG. 25, the layout screen includes, for example, a Gantt chart in which a horizontal axis is a time axis, indicating an operating state of a certain apparatus in a factory to be managed, and a display component (hereinafter also referred to as a video component) for playing back a captured video of the apparatus captured by a camera installed in the factory.

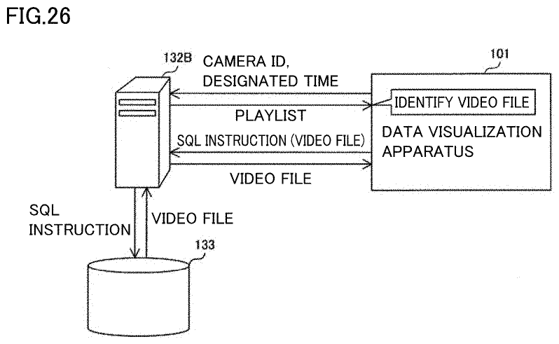

FIG. 26 is a diagram schematically illustrating a method of using a video in the management system according to the embodiment of the present disclosure.

Referring to FIGS. 26 and 1, when input reception unit 16 receives, for example, an operation of selecting a part of Gantt chart by a user, input reception unit 16 outputs operation information including an ID of the above apparatus (hereinafter, also referred to as an apparatus ID) and a time corresponding to the part of Gantt chart selected by the user (hereinafter, also referred to as a designated time) to confirmation screen creating unit 22.

Confirmation screen creating unit 22 receives the operation information from input reception unit 16 and obtains the apparatus ID and the designated time included in the received operation information.

Then, confirmation screen creating unit 22 identifies an ID of a camera (hereinafter also referred to as a camera ID) that is associated with the obtained apparatus ID, and creates an SQL instruction for requesting a playlist which is in accordance with an HTTP Live Streaming (HLS) format and includes the identified camera ID and the obtained designated time.

Confirmation screen creating unit 22 creates an http post including the created SQL instruction, and transmits the created http post to server 132B via data obtaining unit 11.

Server 132B receives the http post from data visualization apparatus 101, obtains the SQL instruction included in the received http post, and obtains the playlist indicated by the obtained SQL instruction from database 133.

Then, server 132B creates an http response including the playlist obtained as target data and transmits the http response to data visualization apparatus 101.

Upon receiving the http response from server 132B, data obtaining unit 11 in data visualization apparatus 101 obtains the target data included in the received http response, and outputs the obtained target data to confirmation screen creating unit 22 in processing unit 14.

Confirmation screen creating unit 22 analyzes the target data, that is, the playlist received from data obtaining unit 11 to specify a video file indicated by the playlist.

Then, confirmation screen creating unit 22 obtains the SQL instruction included in the display component information of the video component from storage unit 17, and edits a part corresponding to the video file in the obtained SQL instruction to the specified video file.

Subsequently, confirmation screen creating unit 22 creates an http post including the edited SQL instruction and the URLc for access processing, and transmits the created http post to server 132B via data obtaining unit 11.

Server 132B receives the http post from data visualization apparatus 101, obtains the SQL instruction included in the received http post, and obtains the video file indicated by the obtained SQL instruction from database 133.

Then, server 132B creates an http response including the video file obtained as target data and transmits the http response to data visualization apparatus 101.

Upon receiving the http response from server 132B, data obtaining unit 11 in data visualization apparatus 101 obtains the target data included in the received http response, and outputs the obtained target data to confirmation screen creating unit 22 in processing unit 14.

Then, confirmation screen creating unit 22 obtains, for example, an OSS library for drawing a video component from storage unit 17, and draws the video component based on the target data received from data obtaining unit 11 on the layout screen using the obtained OSS library.

### [User Management Processing]

When a user is a system administrator, for example, the user can perform user management processing by performing a predetermined operation to data visualization apparatus 101 using a keyboard, a mouse, or the like.

When the predetermined operation is performed, input reception unit 16 outputs operation information indicating the content of the operation by the user to processing unit 14.

Processing unit 14 performs processing of creating a user management screen based on the operation information received from input reception unit 16 and processing of displaying the created user management screen on display 131.

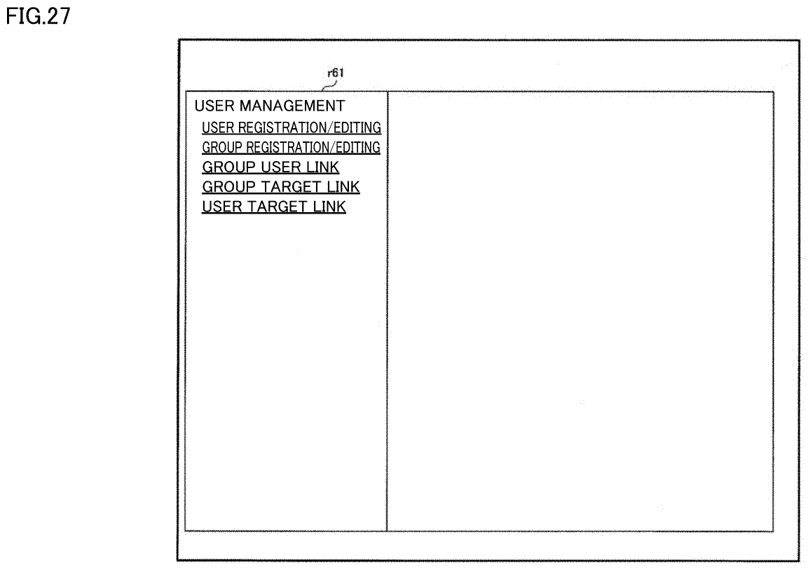

FIG. 27 is a diagram illustrating an example of a user management screen displayed on a display in the management system according to the embodiment of the present disclosure.

Referring to FIG. 27, a region r61 of a user management screen includes process names in which hyperlinks corresponding to a plurality of processes are set, respectively.

A user who is a system administrator can perform processing such as addition, change, and deletion of at least one of a user ID or a corresponding user type stored in database 133 as user management processing.

More specifically, for example, the user performs an operation of selecting “user registration/editing” on the user management screen to data visualization apparatus 101.

When the operation is performed, input reception unit 16 outputs operation information indicating content of the operation by the user to processing unit 14.

Based on the operation information received from input reception unit 16, processing unit 14 creates an http post including a SQL instruction with content for requesting the plurality of user IDs and the corresponding user types (hereinafter collectively referred to as user data) included in the user management table, which is stored in database 133 and indicates the correspondence between user ID and user type, and the URLc for access processing, and transmits the created http post to server 132B via data obtaining unit 11.

Server 132B receives the http post from data visualization apparatus 101, obtains the SQL instruction included in the received http post, and obtains the user data from the user management table in database 133 in accordance with the obtained SQL instruction.

Then, server 132B creates an http response including the obtained user data and transmits the http response to data-visualization apparatus 101.

Upon receiving the http response from server 132B, data obtaining unit 11 in data-visualization apparatus 101 obtains the user data included in the received http response and outputs the user data to processing unit 14.

Based on the user data received from data obtaining unit 11, processing unit 14 creates a user management table indicating a correspondence between the plurality of user IDs and the corresponding user types, and performs processing of displaying a screen including the created user management table on display 131.

For example, the user performs, to data visualization apparatus 101, an operation of performing processing such as addition, change, and deletion of at least one of the user ID or the user type to the user management table on the screen displayed on display 131.

When the operation is performed, input reception unit 16 outputs operation information indicating the content of the operation by the user to processing unit 14.

Based on the operation information received from input reception unit 16, processing unit 14 creates an SQL instruction with content updating the user management table in database 133, creates an http post including the created SQL instruction and the URLc for access processing, and transmits the created http post to server 132B via data obtaining unit 11.

Server 132B receives the http post from data visualization apparatus 101, obtains the SQL instruction included in the received http post, and updates the user management table in database 133 in accordance with the obtained SQL instruction.

A user who is a system administrator can perform processing such as creation, change, and deletion of a user group including one or more user IDs as user management processing.

More specifically, the user performs, for example, an operation of selecting “group registration/editing” on the user management screen illustrated in FIG. 27 to data visualization apparatus 101.

When the operation is performed, input reception unit 16 outputs operation information indicating the content of the operation by the user to processing unit 14.

Based on the operation information received from input reception unit 16, processing unit 14 creates an http post including an SQL instruction with content requesting one or more user group names stored in database 133 and the URLc for access processing, and transmits the created http post to server 132B via data obtaining unit 11.

Server 132B receives the http post from data visualization apparatus 101, obtains the SQL instruction included in the received http post, and obtains the user group name from database 133 in accordance with the obtained SQL instruction.

Then, server 132B creates an http response including the obtained user group name and transmits the http response to data visualization apparatus 101.

Upon receiving the http response from server 132B, data obtaining unit 11 in data visualization apparatus 101 obtains the user group name included in the received http response, and outputs the obtained user group name to processing unit 14.

Processing unit 14 performs processing of displaying a user management screen including the user group name received from data obtaining unit 11 on display 131.

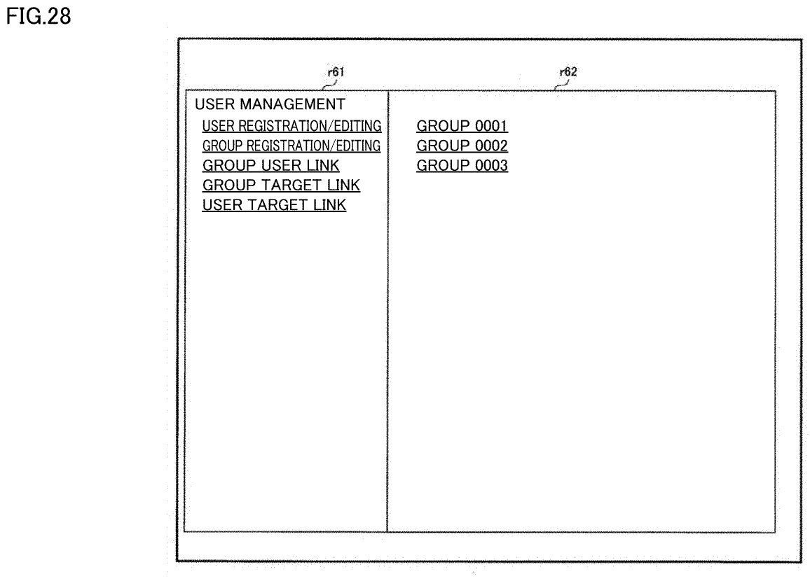

FIG. 28 is a diagram illustrating an example of a user management screen including a user group name, which is displayed on a display in the management system according to the embodiment of the present disclosure.

Referring to FIG. 28, a region r62 of the user management screen includes one or more user group names received from data obtaining unit 11. FIG. 28 illustrates a user management screen including three user group names as an example.

A user performs, to data visualization apparatus 101, an operation of conducting processing such as addition of a new user group name, and change and deletion of a user group name included in region r62.

When the predetermined operation is performed, input reception unit 16 outputs operation information indicating the content of the operation by the user to processing unit 14.

Based on the operation information received from input reception unit 16, processing unit 14 creates an SQL instruction having content of updating the user group name in database 133, and creates a http post including the created SQL instruction and the URLc for access processing to transmit the created http post to server 132B via data obtaining unit 11.

Server 132B receives the http post from data visualization apparatus 101 to obtain the SQL instruction included in the received http post, and updates the user group name in database 133 in accordance with the obtained SQL instruction.

A user who is a system administrator can perform processing such as registration, change, and deletion of one or more user IDs included in a user group as user management processing.

More specifically, the user performs, to data visualization apparatus 101, an operation of selecting “group user link” on the user management screen illustrated in FIG. 28, for example.

When the operation is performed, input reception unit 16 outputs operation information indicating content of the operation by the user to processing unit 14.

Based on the operation information received from input reception unit 16, processing unit 14 creates an http post including a SQL instruction, which has content of requesting one or more user group names stored in database 133 and one or more user IDs included in corresponding user groups stored in database 133 (hereinafter collectively referred to as group data), and the URLc for access processing, and then transmits the created http post to server 132B via data obtaining unit 11.

Server 132B receives the http post from data visualization apparatus 101 to obtain the SQL instruction included in the received http post, and obtains the group data from database 133 in accordance with the obtained SQL instruction.

Then, server 132B creates an http response including the obtained group data and transmits the http response to data visualization apparatus 101.

Upon receiving the http response from server 132B, data obtaining unit 11 in data visualization apparatus 101 obtains the group data included in the received http response and outputs the obtained group data to processing unit 14.

Based on the group data received from data obtaining unit 11, processing unit 14 creates a user group table Tab5, which indicates a correspondence between one or more user group names and one or more user IDs included in the corresponding user groups, and performs processing of displaying a user management screen including the created user group table Tab5 on a display 131.

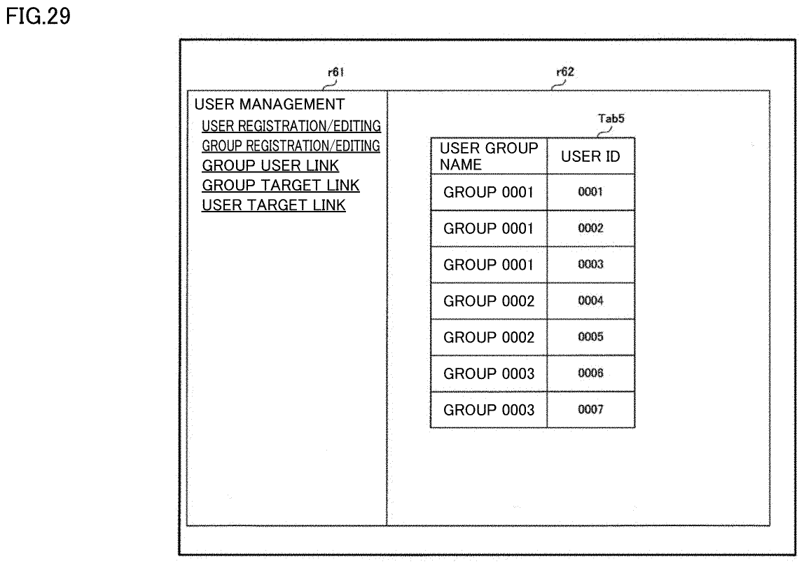

FIG. 29 is a diagram illustrating an example of a user management screen including a user group table displayed on a display in the management system according to the embodiment of the present disclosure.

Referring to FIG. 29, in user group table Tab5 in region r62 of the user management screen, group 0001 includes user IDs “0001”, “0002”, and “0003”. Group 0002 includes user IDs “0004” and “0005”. Group 0003 includes user IDs “0006” and “0007”.

A user performs, to data visualization apparatus 101, an operation of performing processing of updating a group data, such as processing of registering a new user ID in group 0001 included in user group table Tab5 and processing of deleting one or more user IDs included in group 0001.

When the operation is performed, input reception unit 16 outputs operation information indicating the content of the operation by the user to processing unit 14.

Based on the operation information received from input reception unit 16, processing unit 14 creates an SQL instruction having content of updating the group data in database 133, creates an http post including the created SQL instruction and the URLc for access processing, and transmits the created http post to server 132B via data obtaining unit 11.

Server 132B receives the http post from data visualization apparatus 101, obtains the SQL instruction included in the received http post, and updates the group data in database 133 in accordance with the obtained SQL instruction.

Thus, in data visualization apparatus 101, a user can create various display components corresponding to various applications.

In addition, in data visualization apparatus 101, since a user can easily create various confirmation screens corresponding to various applications by using display components, it is possible to easily grasp the states of components, apparatuses, buildings, and the like to be managed.

Further, in data visualization apparatus 101, since various authority can be set for processing using a database in accordance with the type of user, it is possible to set appropriate authority in accordance with the type of user. As a result, for example, an increase in the processing load of database 133 can be suppressed, and database 133 can be used more smoothly even by a user having little knowledge about the database.

### [Flow of Operation]

Each of a plurality of apparatus in management system 201 includes a computer including a memory, and an arithmetic processing unit such as a CPU in the computer reads a program including a part or all of each step of the following flowchart from the memory to execute the program. Each program of the plurality of apparatus can be installed from the outside. Each program of the plurality of apparatus is distributed in a form of being stored in a recording medium.

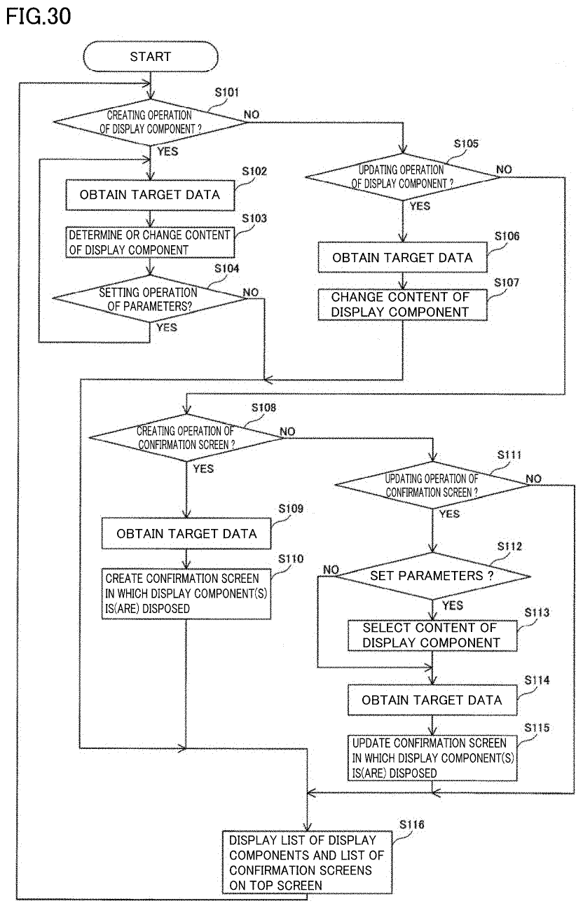

FIG. 30 is a flowchart defining an operation procedure when the data visualization apparatus in the management system according to the embodiment of the present disclosure displays a confirmation screen on the display.

Referring to FIG. 30, first, when data visualization apparatus 101 receives an operation by a user whose content is to create a display component (YES in step S101), data visualization apparatus 101 obtains target data, which is at least one of measurement data or a calculation result of calculation using the measurement data, from database 133 via server 132B (step S102).

Next, data visualization apparatus 101 creates the display component based on the obtained target data. That is, data visualization apparatus 101 determines the content of the display component based on the obtained target data (step S103).

Next, when data visualization apparatus 101 receives an operation by the user whose content is to change one or more parameters (YES in step S104), data visualization apparatus 101 obtains target data from database 133 via server 132B in accordance with the one or more parameters by the operation (step S102), and changes the content of the display component based on the obtained target data (step S103).

On the other hand, when the operation by the user whose content is to change the parameters is not performed (NO in step S104), data visualization apparatus 101 ends the creation of the display component and performs processing of displaying a list of types of display components and a list of types of confirmation screens on one top screen (step S116). Then, data visualization apparatus 101 waits for a new operation by the user (step S101).

Next, when data visualization apparatus 101 receives an operation by the user whose content is to create another display component (YES in step S101), data visualization apparatus 101 performs processing in steps S102 to S104. Thus, data visualization apparatus 101 creates a plurality of display components.

Next, when data visualization apparatus 101 receives an operation by the user whose content is to update the created display component (NO in step S101 and YES in step S105), data visualization apparatus 101 obtains target data from database 133 via server 132B in accordance with one or more parameters by the operation by the user (step S106).

Next, data visualization apparatus 101 updates the display component based on the obtained target data. That is, data visualization apparatus 101 changes the content of the display component in accordance with one or more parameters (step S107).

Next, data visualization apparatus 101 performs processing of displaying a list of types of display components and a list of types of confirmation screens on one top screen (step S116). Then, data visualization apparatus 101 waits for a new operation by the user (step S101).

Next, when data visualization apparatus 101 receives an operation by the user whose content is to create a confirmation screen (NO in step S101, NO in step S105, and YES in step S108), data visualization apparatus 101 obtains target data from database 133 via server 132B in accordance with one or more parameters by the operation by the user (step S109).

Next, data visualization apparatus 101 performs, based on the obtained target data, processing of causing content related to the measurement data to be displayed on the confirmation screen.

More specifically, data visualization apparatus 101 creates a confirmation screen in which one or more display components are disposed based on the obtained target data (step S110). That is, data visualization apparatus 101 selects content of the display component in the confirmation screen in accordance with one or more parameters by the above operation by the user.

Next, data visualization apparatus 101 performs processing of displaying a list of types of display components and a list of types of confirmation screens on one top screen (step S116). Then, data visualization apparatus 101 waits for a new operation by the user (step S101).

Next, when data visualization apparatus 101 receives an operation by the user whose content is to create another confirmation screen (NO in step S101, NO in step S105, and YES in step S108), data visualization apparatus 101 performs processing in steps S109 and S110. Thus, data visualization apparatus 101 creates a plurality of confirmation screens.

On the other hand, when data visualization apparatus 101 receives an operation by the user whose content is to update the confirmation screen (NO in step S101, NO in step S105, NO in step S108, and YES in step S111) and when the content of the operation includes the change of one or more parameters (YES in step S112), data visualization apparatus 101 selects the content of the display component in the confirmation screen by changing the parameters in accordance with the operation by the user (step S113).

Then, data visualization apparatus 101 obtains target data in accordance with the changed parameters from database 133 via server 132B (step S114).

On the other hand, when the content of the operation does not include the change of the one or more parameters (NO in step S112), data visualization apparatus 101 obtains target data from database 133 via server 132B (step S114).

Next, data visualization apparatus 101 updates the confirmation screen in which one or more display components are disposed based on the obtained target data (step S115).

Next, data visualization apparatus 101 performs processing of displaying a list of types of display components and a list of types of confirmation screens on one top screen (step S116). Then, data visualization apparatus 101 waits for a new operation by the user (step S101).

### [Modification 1]

In data visualization apparatus 101, for example, processing unit 14 may be configured to perform, in accordance with an operation by a user, processing of displaying a display component constituting a confirmation screen on a top screen such that the display component is recognizable, that is, processing of displaying a correspondence between display components and confirmation screens such that the correspondence is recognizable.

More specifically, the user performs, to data visualization apparatus 101, an operation of selecting “screen name” or “content” of one confirmation screen included in confirmation screen table Tab1 on a top screen, for example.

When the operation is performed, input reception unit 16 outputs operation information indicating the content of the operation by the user to processing unit 14.

Based on the operation information received from input reception unit 16, processing unit 14 performs processing of changing the colors of the “screen name” and the “content” of the confirmation screen selected by the user in the confirmation screen table Tab1.

In addition, processing unit 14 performs processing of changing the colors of the “display component name” and the “type” of the display component included in the confirmation screen selected by the user based on the operation information received from input reception unit 16.

More specifically, referring to FIG. 1, processing unit 14 obtains, from storage unit 17, various parameters of one or more display components included in the confirmation screen information corresponding to the confirmation screen selected by the user, and specifies the display component included in the confirmation screen based on the obtained various parameters.

Then, processing unit 14 creates a top screen including confirmation screen table Tab1 in which the colors of “screen name” and “content” of the confirmation screen selected by the user are changed and display component table Tab2 in which the colors of “display component name” and “type” of the specified display component are changed, and performs processing of displaying the created top screen on display 131.

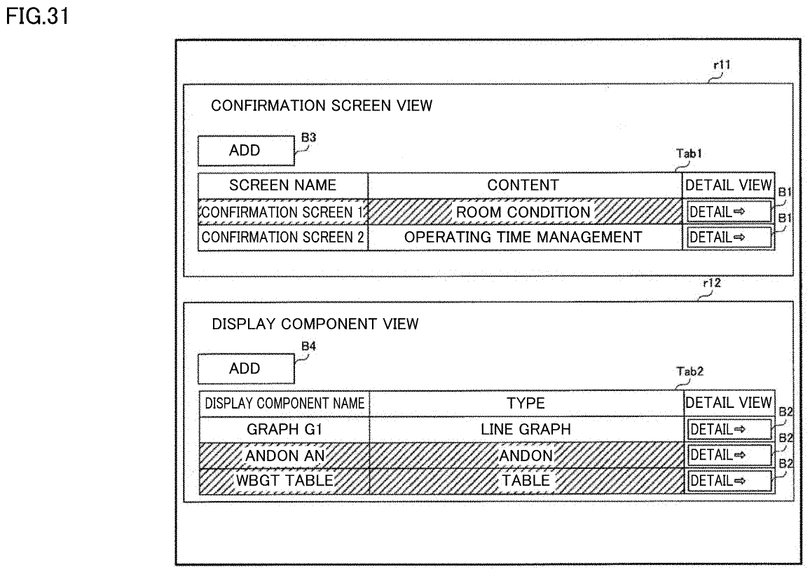

FIG. 31 is a diagram illustrating a state in which a confirmation screen is selected on a top screen in the management system according to the embodiment of the present disclosure. FIG. 31 illustrates a state in which “confirmation screen 1” is selected as an example.

Referring to FIG. 31, on the top screen, the colors of “screen name” and “content” of the selected “confirmation screen 1” are changed, and the colors of “display component name” and “type” of each of “Andon An” and “WBGT table”, which are the display components included in “confirmation screen 1”, are changed. In FIG. 31, the color change is indicated by hatching.

Further, the user performs, to data visualization apparatus 101, an operation of selecting “display component name” or “type” of one display component included in display component table Tab2 on the top screen, for example.

When the operation is performed, input reception unit 16 outputs operation information indicating the content of the operation by the user to processing unit 14.

Processing unit 14 performs processing of changing the colors of “display component name” and “type” of the display component selected by the user in display component table Tab2 based on the operation information received from input reception unit 16.

In addition, processing unit 14 performs processing of changing the colors of “screen name” and “content” of the confirmation screen including the display component selected by the user based on the operation information received from input reception unit 16.

More specifically, processing unit 14 obtains, from storage unit 17, one or more pieces of confirmation screen information including “display component name” of the display component selected by the user as a parameter, and specifies the confirmation screen indicated by the obtained confirmation screen information.

Then, processing unit 14 creates a top screen including display component table Tab2 in which the colors of “display component name” and “type” of the display component selected by the user are changed and confirmation screen table Tab1 in which the colors of the “screen name” and the “content” of the specified confirmation screen are changed, and performs processing of displaying the created top screen on the display 131.

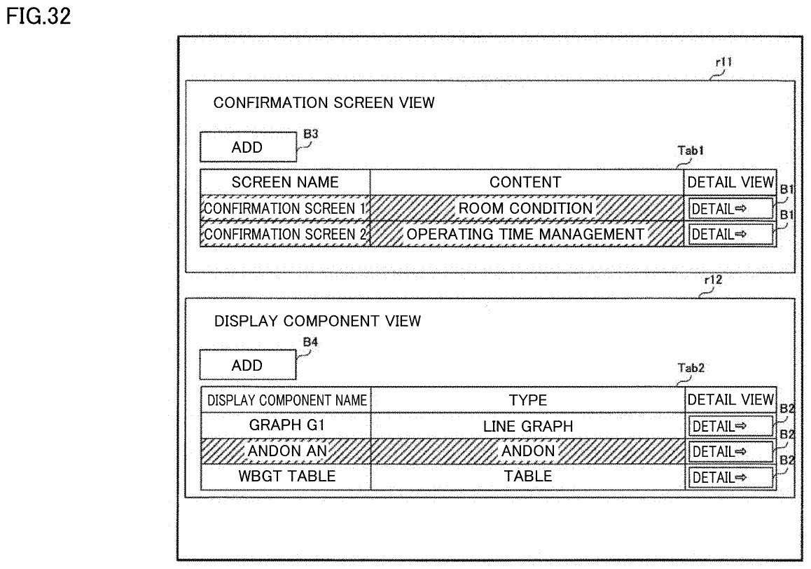

FIG. 32 is a diagram illustrating a state in which a display component is selected in a top screen in the management system according to the embodiment of the present disclosure. FIG. 32 illustrates a state in which “Andon An” is selected as an example.

Referring to FIG. 32, on the top screen, the colors of “display component name” and “type” of the selected “Andon An” are changed, and the colors of “screen name” and “content” of each of “confirmation screen 1” and “confirmation screen 2” which are confirmation screens including “Andon An” are changed. In FIG. 32, the color change is indicated by hatching.

In this way, the user can easily grasp each display component and each confirmation screen, which are targeted by the data visualization apparatus, as a whole. Further, the user can easily grasp a correspondence between display components and confirmation screens.

In addition, in data visualization apparatus 101, for example, processing unit 14 may be configured to display a usage status of display components in a confirmation screen on the component editing screen illustrated in FIG. 9.

More specifically, as described above, when updating a created display component, processing unit 14 obtains corresponding display component information from storage unit 17. Then, for example, when “display component name” among various parameters included in the obtained display component information is included in one or more pieces of confirmation screen information in storage unit 17, processing unit 14 obtains the one or more pieces of confirmation screen information from storage unit 17 and specifies a confirmation screen indicated by the obtained confirmation screen information.

Processing unit 14 includes information indicating the specified confirmation screen in the display component information, and executes a creation program using the SQL instruction included in the display component information.

Thus, display component creating unit 21 creates a display component based on the display component information, and outputs a component editing screen of the created display component to display processing unit 23.

Display processing unit 23 performs processing of displaying the component editing screen received from display component creating unit 21 on display 131.

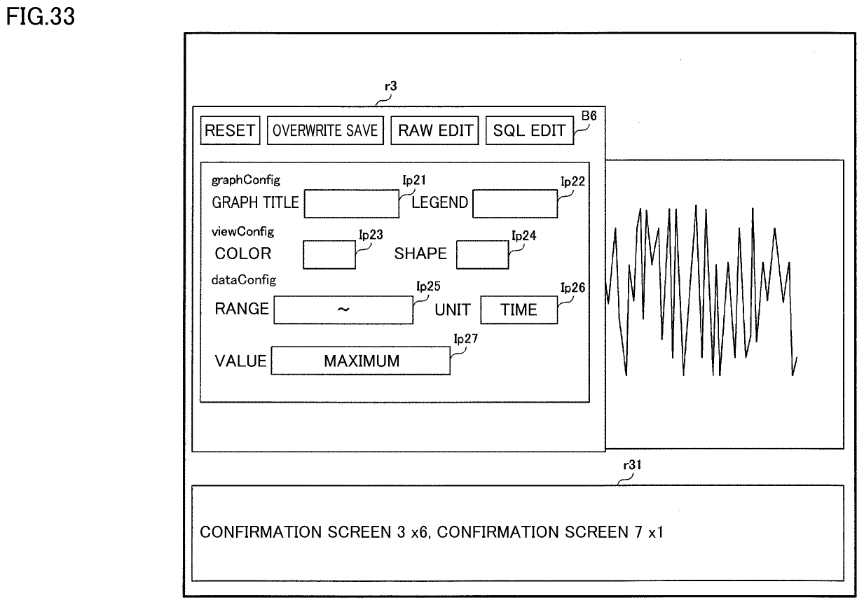

FIG. 33 is a diagram illustrating another example of a component editing screen displayed on a display in the management system according to the embodiment of the present disclosure.

Referring to FIG. 33, compared with the component editing screen illustrated in FIG. 9, the component editing screen further includes a region r31 for displaying information of a confirmation screen including a display component corresponding to the component editing screen.

Region r31 includes, for example, “screen name” of the confirmation screen including graph G1 corresponding to the component editing screen, the number of graph G1 included in the confirmation screen and the like.

Thus, a user can easily know where the edit of the display component will affect.

### [Modification 2]

Data visualization apparatus 101 may be configured to limits update of a display component performed by a user different from a user who has created the display component.

More specifically, display component creating unit 21 in data visualization apparatus 101 creates, for example, a component editing screen on which “open setting” for setting a user who can update a display component to be created can be performed.

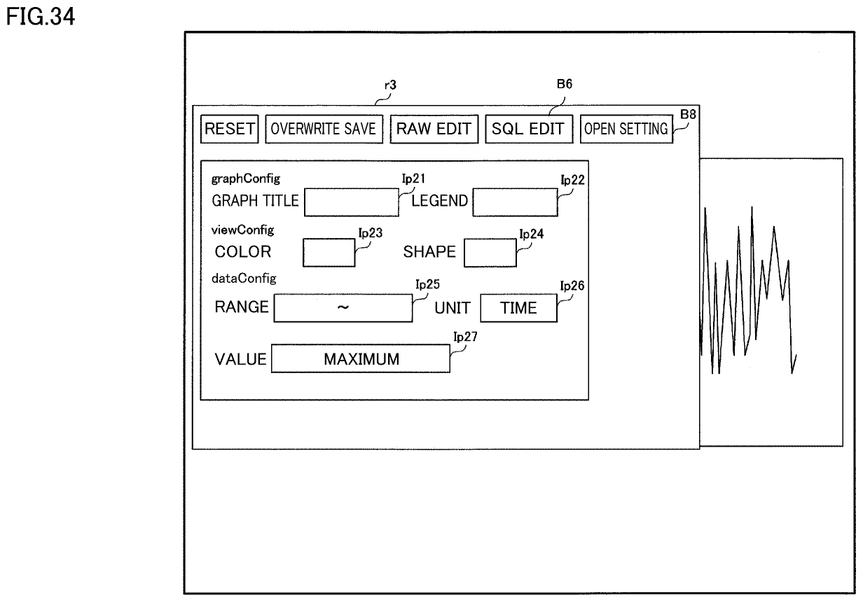

FIG. 34 is a diagram illustrating an example of a component editing screen capable of performing the open setting displayed on a display according to an embodiment of the present disclosure.

Referring to FIG. 34, compared with the component editing screen illustrated in FIG. 9, the component editing screen further includes a button B8 for performing the open setting in the region r3.

The user performs an operation of pressing button B8 to the Web browser.

For example, when input reception unit 16 receives the operation by the user, input reception unit 16 outputs operation information indicating the content of the operation by the user to display component creating unit 21 in processing unit 14.

Based on the operation information received from input reception unit 16, display component creating unit 21 creates an http post including a SQL instruction for requesting data (hereinafter also referred to as an editing authority data) which is stored in database 133 and relates the user ID to the user type and whether or not the target display component can be edited or viewed (hereinafter, also referred to as an editing authority information), and the URLc for access processing. Then, data obtaining unit 11 transmits the created http post to server 132B via data obtaining unit 11.

Server 132B receives the http post from data visualization apparatus 101 to obtain the SQL instruction included in the received http post, and obtains the editing authority data from database 133 in accordance with the obtained SQL instruction.

Then, server 132B creates an http response including the obtained editing authority data, and transmits the http response to data visualization apparatus 101.

Upon receiving the http response from server 132B, data obtaining unit 11 in data visualization apparatus 101 obtains the editing authority data included in the received http response, and outputs the obtained editing authority data to display component creating unit 21 in processing unit 14.

Display component creating unit 21 creates an open setting screen based on the editing authority data received from data obtaining unit 11, and outputs the created open setting screen to display processing unit 23.

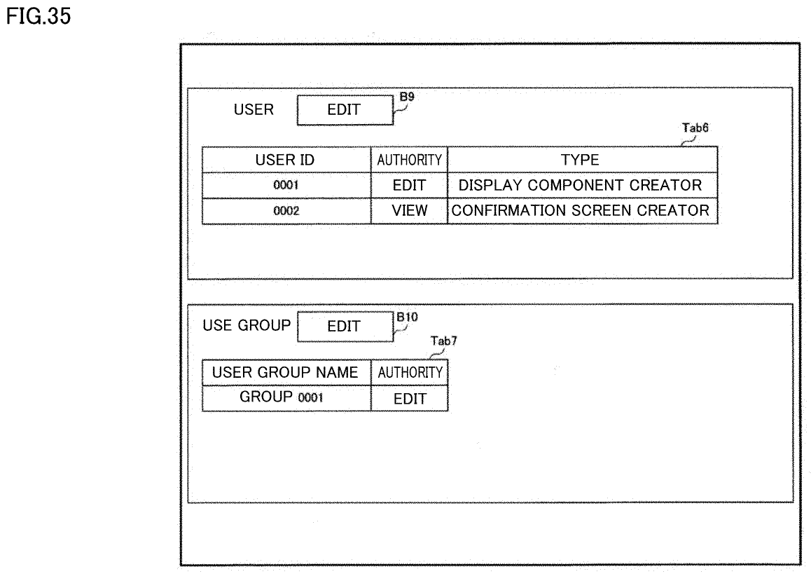

FIG. 35 is a diagram illustrating an example of an open setting screen displayed on a display according to the embodiment of the present disclosure.

Referring to FIG. 35, the open setting screen includes a table Tab6 indicating a user who can edit or view the display component corresponding to the open setting screen, a table Tab7 indicating a user group who can edit or view the display component, a button B9 for editing the table Tab6, and a button B10 for editing table Tab7.

A user can set a user who can update the display component by editing table Tab6, for example.

More specifically, the user performs an operation of pressing button B9 to the Web browser.

For example, when input reception unit 16 receives the operation by the user, input reception unit 16 outputs operation information indicating the content of the operation by the user to display component creating unit 21 in processing unit 14.

Display component creating unit 21 outputs the editing authority data to the restriction unit 18 based on the operation information received from input reception unit 16.

Restriction unit 18 creates, based on the editing authority data received from processing unit 14, a user open setting screen including table Tab8 including the user ID and the corresponding editing authority information, and table Tab9 including a user ID for which the editing authority information is not set, and outputs the created user open setting screen to processing unit 14.

Processing unit 14 performs processing of displaying, on display 131, the user open setting screen received from restriction unit 18.

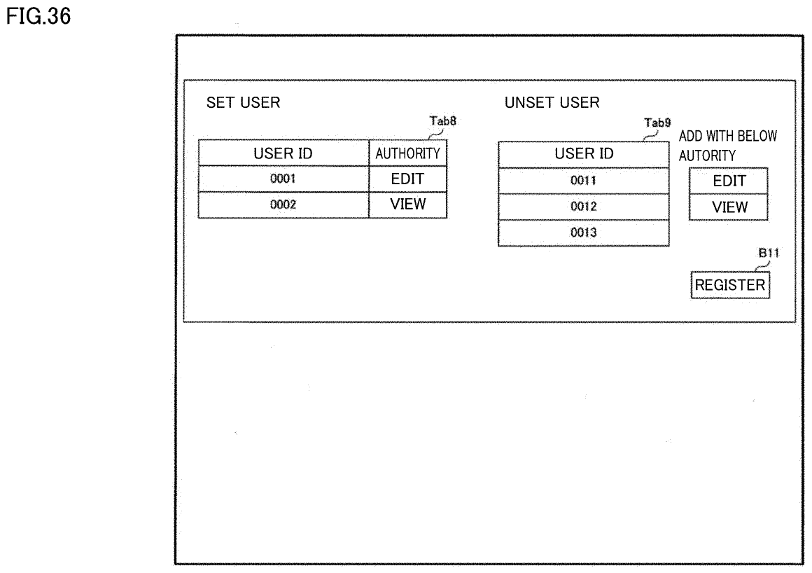

FIG. 36 is a diagram illustrating an example of a user open setting screen displayed on a display according to the embodiment of the present disclosure.

Referring to FIG. 36, the user open setting screen includes table Tab8, table Tab9, fields for allowing the user to select edit authority information, and a registration button B11.

For example, the user selects any one of the user IDs included in table Tab9 and either one of “edit” and “view”, and then performs an operation of pressing registration button B11 to the Web browser.

For example, when input reception unit 16 receives the operation by the user, input reception unit 16 outputs operation information including the user ID and the content selected by the user to processing unit 14.

Processing unit 14 creates an editing authority information corresponding to the selected content based on the operation information received from input reception unit 16, and outputs the created editing authority information and the user ID included in the operation information to restriction unit 18.

Restriction unit 18 updates the editing authority data by adding the user ID and the editing authority information received from processing unit 14 to the editing authority data.

Then, restriction unit 18 updates table Tab8 and table Tab9 based on the updated editing authority data, creates a user open setting screen including each of the updated tables, and outputs the created user open setting screen to processing unit 14.

Restriction unit 18 outputs the updated editing authority data to display component creating unit 21.

Display component creating unit 21 updates table Tab6 and table Tab7 based on the updated editing authority data received from restriction unit 18.

Specifically, display component creating unit 21 adds the user ID and the editing authority information which are added to the editing authority data to table Tab6, and deletes the user ID from table Tab7. That is, a user who can update or view the display component is added to data visualization apparatus 101.

Then, display component creating unit 21 creates an open setting screen including the updated tables and outputs the created open setting screen to display processing unit 23.

In addition, based on the updated editing authority data received from restriction unit 18, display component creating unit 21 creates an http post including an SQL instruction for updating the editing authority data in database 133 and the URLc for access processing and transmits the created http post to server 132B via data obtaining unit 11.

Server 132B receives the http post from the data visualization apparatus 101 to obtain the SQL instruction included in the received http post, and updates the editing authority data in database 133 in accordance with the obtained SQL instruction.

Further, a user can set whether or not a display component can be updated for each user group by editing table Tab7 in the same manner as the editing of table Tab6, for example.

More specifically, the user performs an operation of pressing button B10 for editing table Tab7 to the Web browser. The user then performs an operation to data visualization apparatus 101 in accordance with a screen displayed on a display 131 to set whether or not the display component can be updated for each user group.

In addition, for example, restriction unit 18 limits, in update of the display component by display component creating unit 21, the update performed by a user different from a user who has created the display component.

More specifically, among user IDs included in table Tab8 and table Tab9 on the user open setting screen, for example, the user sets the editing authority information of the user's own user ID to “edit” and sets the editing authority information of other user IDs to “view” or does not set the editing authority information of other user IDs, thereby limiting the update by a user different from a user who has created the display component.

Restriction unit 18 updates the editing authority data in accordance with setting content of the editing authority information by the user.

This limits the update of the display component by display component creating unit 21.

As in the above example, in data visualization apparatus 101, in a state in which update of a display component by a user different from a user who has created the display component is limited, in access processing, for example, display component creating unit 21 includes a http cookie indicating a user ID and a user type of a user (hereinafter also referred to as an operating user) who is performing an operation to data visualization apparatus 101, and information indicating a target display component in a http post together with a SQL instruction, and transmits the http post to server 132B.

Server 132B receives the http post from data visualization apparatus 101 to obtain the http cookie included in the received http post, and specifies the user ID and the user type indicated by the obtained http cookie.

Server 132B also specifies the target display component based on the information indicating the target display component included in the http post.

Then, server 132B refers to the editing authority data in database 133 to confirm the editing authority information corresponding to the specified user ID and the target display component.

For example, when the confirmed edit authority information is “edit”, server 132B performs processing in accordance with the SQL instruction included in http post.

On the other hand, for example, when the confirmed editing authority information is “view” or not yet set, server 132B creates an http response including information indicating that processing in accordance with the SQL instruction is not permitted, and transmits the http response to data visualization apparatus 101.

Upon receiving the http response from server 132B, data obtaining unit 11 in data visualization apparatus 101 obtains information indicating that the processing in accordance with the SQL instruction included in the received http response is not permitted, and outputs the obtained editing authority data to display component creating unit 21 in processing unit 14.

Display component creating unit 21 creates, for example, a screen for notifying the user that editing of a display component is not permitted based on the information indicating that the processing in accordance with the SQL instruction received from data obtaining unit 11 is not permitted, and outputs the created screen to display processing unit 23.

In management system 201 according to the embodiment of the present disclosure, each of servers 132A, 132B and database 133 is a single apparatus, but the present disclosure is not limited thereto. Some or all of the functions of servers 132A, 132B and database 133 may be provided by cloud computing. That is, each of servers 132A, 132B and database 133 may be configured by a plurality of cloud servers or the like.

In management system 201 according to the embodiment of the present disclosure, the number of types of users is four, but the present disclosure is not limited thereto. The number of types of users may be two, three, or five or more.

In data visualization apparatus 101 according to the embodiment of the present disclosure, processing unit 14 is configured to display a top screen corresponding to the type of user on display 131. However, the configuration is not limited thereto. Processing unit 14 may be configured to display a top screen common to all types of user on display 131.

In this case, for example, when a user performs, to data visualization apparatus 101, an operation that is not permitted to the type of the user, data visualization apparatus 101 performs processing of displaying, on display 131, a message indicating that the operation is not permitted.

In data visualization apparatus 101 according to the embodiment of the present disclosure, authorization unit 15 is configured to grant narrower authority to confirmation screen creating unit 22 than to display component creating unit 21, but the present disclosure is not limited thereto. Authorization unit 15 may be configured to grant the same range of authority to confirmation screen creating unit 22 as that of display component creation unit 21.

In data visualization apparatus 101 according to the embodiment of the present disclosure, authorization unit 15 is configured to grant narrower authority to display processing unit 23 than to confirmation screen creating unit 22, but the present disclosure is not limited thereto. Authorization unit 15 may be configured to grant the same range of authority to display processing unit 23 as that of confirmation screen creating unit 22.

In data visualization apparatus 101 according to the embodiment of the present disclosure, authorization unit 15 is configured to grant authority including at least any one of authority to set a temporal range and a unit of time of the measurement data to be obtained from the database, and authority to set a type of calculation using the measurement data, but the configuration is not limited thereto. Authorization unit 15 may be configured to grant authority to set other types than the above.

In data visualization apparatus 101 according to the embodiment of the present disclosure, confirmation screen creating unit 22 has a configuration capable of creating a confirmation screen in which a plurality of types of display components are disposed, but the configuration is not limited thereto. Confirmation screen creating unit 22 may be configured to create a confirmation screen in which a single type of display component is disposed without having a function of creating a confirmation screen in which a plurality of types of display components are disposed.

Further, in data visualization apparatus 101 according to the embodiment of the present disclosure, confirmation screen creating unit 22 has a configuration capable of creating a plurality of confirmation screens, but the configuration is not limited thereto.

Confirmation screen creating unit 22 may be configured to create one confirmation screen without having a function of creating a plurality of confirmation screens. In this case, for example, processing unit 14 does not display a list of types of confirmation screens on a top screen, but displays a list of types of display components on the top screen.

In data visualization apparatus 101 according to the embodiment of the present disclosure, display component creating unit 21 and confirmation screen creating unit 22 are configured to create or update a display component and a confirmation screen, respectively, in accordance with an instruction by a user, but the configuration is not limited thereto. Display component creating unit 21 and confirmation screen creating unit 22 may be configured to create or update a predetermined display component and a predetermined confirmation screen, respectively. More specifically, display component creating unit 21 obtains a predetermined target data from database 133, for example, and automatically creates a display component based on the obtained target data. Confirmation screen creating unit 22 automatically creates a predetermined confirmation screen including the display component, for example.

Further, in data visualization apparatus 101 according to the embodiment of the present disclosure, confirmation screen creating unit 22 is configured to set one or more parameters in accordance with an instruction by a user, but the configuration is not limited thereto. The parameters may be configured to be automatically set by confirmation screen creating unit 22, for example.

It is desirable to have a technology that can improve user convenience in a configuration of visualizing the information stored in the database.

On the other hand, in the data visualization apparatus according to the embodiment of the present disclosure, data obtaining unit 11 obtains target data that is at least one of measurement data obtained from database 133 in which the measurement data based on a measurement result is stored or a calculation result of calculation using the measurement data in database 133. Based on the target data obtained by data obtaining unit 11, processing unit 14 performs processing of causing content related to the measurement data to be displayed on the confirmation screen. Display component creating unit 21 creates or updates one or more display components constituting the confirmation screen. Confirmation screen creating unit 22 creates or updates the confirmation screen by disposing the display components created by display component creating unit 21. Display component creating unit 21 can change the content of the display components in accordance with one or more parameters. Confirmation screen creating unit 22 can select the content of the display component in the confirmation screen by setting the parameters.

With this configuration, various confirmation screens corresponding to various applications can be easily created, and also various display components can be displayed on the confirmation screen by setting parameters. In a state where a plurality of types of display components having different parameter values are created, content of the plurality of types of display components can be changed at a time by changing a value of a parameter different from the parameter.

Therefore, the data visualization apparatus according to the embodiment of the present disclosure can improve user convenience in a configuration in which the measurement data obtained from the database is visualized.

Further, in the data visualization apparatus according to the embodiment of the present disclosure, confirmation screen creating unit 22 can create a confirmation screen in which a plurality of types of display components are disposed by setting parameters.

With this configuration, since various display components can be displayed on one confirmation screen, a screen with a larger amount of information can be provided to a user.

In the data visualization apparatus according to the embodiment of the present disclosure, confirmation screen creating unit 22 can create a plurality of confirmation screens. Processing unit 14 performs processing of causing one screen to display a list of types of display components and a list of types of confirmation screens. Processing unit 14 further performs, in accordance with an operation by a user, processing of displaying a correspondence between display components and confirmation screens such that the correspondence is recognizable.

With this configuration, it is possible to easily grasp each display component and each confirmation screen, which are targeted by the data visualization apparatus, as a whole. Further, the user can easily grasp a correspondence between display components and confirmation screens.

In addition, in the data visualization apparatus according to the embodiment of the present disclosure, processing unit 14 performs processing of displaying an editing screen of display components, and displays a usage status of the display components on the editing screen.

With this configuration, it is easy for a user to know where the edit of the display components will affect.

Further, in the data visualization apparatus according to the embodiment of the present disclosure, restriction unit 18 limits update performed by a user different from a user who has created display components in the update of the display components by the display component creating unit 21.

With this configuration, it is possible to limit the update of the display components separately from authority and to suppress interference between users.

In addition, in the data visualization apparatus according to the embodiment of the present disclosure, data obtaining unit 11 obtains target data that is at least one of measurement data obtained from database 133 in which the measurement data based on a measurement result is stored or a calculation result of calculation using the measurement data in database 133. Based on the target data obtained by data obtaining unit 11, processing unit 14 performs processing of causing content related to the measurement data to be displayed on the confirmation screen. Display component creating unit 21 creates or updates one or more display components constituting the confirmation screen. Confirmation screen creating unit 22 creates or updates the confirmation screen by disposing the display components created by display component creating unit 21. Confirmation screen creating unit 22 can create a plurality of confirmation screens. Processing unit 14 performs processing of causing one screen to display a list of types of display components and a list of types of confirmation screens.

With this configuration, various confirmation screens corresponding to various applications can be easily created, and it is also possible to easily grasp each display component and each confirmation screen, which are targeted by the data visualization apparatus, as a whole.

Therefore, the data visualization apparatus according to the embodiment of the present disclosure can improve user convenience in a configuration in which the measurement data obtained from the database is visualized.

In the data processing method according to the embodiment of the present disclosure, first, target data that is at least one of measurement data obtained from database 133 in which the measurement data based on a measurement result is stored or a calculation result of calculation using the measurement data in database 133 is obtained. Next, one or more display components constituting a confirmation screen are created or updated. Next, the confirmation screen is created or updated by disposing the created display components. Next, based on the obtained target data, processing is performed to cause content related to the measurement data to be displayed on the confirmation screen. When the display components are created or updated, content of the display components is changed in accordance with one or more parameters. When the confirmation screen is created or updated, the content of the display component in the confirmation screen is selected by setting the parameters.

With this configuration, various confirmation screens corresponding to various applications can be easily created, and also various display components can be displayed on the confirmation screens by setting parameters. In a state where a plurality of types of display components having different parameter values are created, content of the plurality of types of display components can be changed at a time by changing a value of a parameter different from the parameter.

Therefore, in the data processing method according to the embodiment of the present disclosure, user convenience can be improved in a configuration in which measurement data obtained from a database is visualized.

In the data processing method according to the embodiment of the present disclosure, first, target data that is at least one of measurement data obtained from database 133 in which the measurement data based on a measurement result is stored or a calculation result of calculation using the measurement data in database 133 is obtained. Next, one or more display components constituting a confirmation screen are created or updated. Next, based on the obtained target data, processing is performed to cause content related to the measurement data to be displayed on the confirmation screen. On creating or updating the confirmation screen, a plurality of confirmation screens are created. Next, a processing of causing one screen to display a list of types of display components and a list of types of confirmation screens is performed.

With this configuration, various confirmation screens corresponding to various applications can be easily created, and also the entire display components and confirmation screens targeted by data visualization apparatus 101 can be easily grasped.

Therefore, the data processing method according to the embodiment of the present disclosure can improve user convenience in a configuration in which the measurement data obtained from the database is visualized.

It should be understood that the above-described embodiments are illustrative in all aspects and should not be recognized as being restrictive. The scope of the present invention is defined by the scope of the claims rather than the above description, and is intended to embrace all the modifications within the meaning and range of equivalency of the claims.

The above description includes the following additional features.

### [Supplementary Note 1]

A data visualization apparatus comprises a data obtaining unit configured to obtain target data that is at least one of measurement data obtained from a database in which the measurement data based on a measurement result is stored or a calculation result of calculation using the measurement data in the database, a processing unit configured to perform, based on the target data obtained by the data obtaining unit, processing of causing content related to the measurement data to be displayed on a confirmation screen, wherein the processing unit includes a display component creating unit configured to create or update one or more display components constituting the confirmation screen and a confirmation screen creating unit configured to create or update the confirmation screen by disposing the one or more display components created by the display component creating unit, wherein the display component creating unit is capable of changing content of each of the one or more display components in accordance with one or more parameters, wherein the confirmation screen creating unit is capable of selecting content of each of the one or more display components in the confirmation screen by setting the one or more parameters, and wherein the confirmation screen creating unit is capable of creating a plurality of the confirmation screens and is capable of selecting content of each of the one or more display components for each of the confirmation screens by setting the one or more parameters.

### [Supplementary Note 2]

A data visualization apparatus comprises a data obtaining unit configured to obtain target data that is at least one of measurement data obtained from a database in which the measurement data based on a measurement result is stored or a calculation result of calculation using the measurement data in the database, a processing unit configured to perform, based on the target data obtained by the data obtaining unit, processing of causing content related to the measurement data to be displayed on a confirmation screen, wherein the processing unit includes a display component creating unit configured to create or update one or more display components constituting the confirmation screen and a confirmation screen creating unit configured to create or update the confirmation screen by disposing the one or more display components created by the display component creating unit, wherein the confirmation screen creating unit is capable of creating a plurality of the confirmation screens, wherein the processing unit performs processing of causing one screen to display a list of one or more types of the one or more display components and a list of types of the confirmation screens, and wherein the confirmation screen creating unit is capable of selecting content of each of the one or more display components for each of the confirmation screens by setting one or more parameters.

### REFERENCE SIGNS LIST

11 data obtaining unit
14 processing unit
15 authorization unit
16 input reception unit
17 storage unit
18 restriction unit
21 display component creating unit
22 confirmation screen creating unit
23 display processing unit
101 data visualization apparatus
131 display
132A, 132B server
133 database
134 network
201 management system

1. A data visualization apparatus comprising:
data obtaining circuitry configured to obtain target data from a database, the target data being at least one of measurement data or a calculation result of a calculation using the measurement data; and
processing circuitry configured to perform, based on the target data obtained by the data obtaining circuitry, processing to create a confirmation screen including the measurement data or the calculation result and processing to cause the confirmation screen to be displayed,
wherein the processing circuitry includes
a display component creating circuitry configured to create or update one or more display components constituting the confirmation screen, and
a confirmation screen creating circuitry configured to create or update the confirmation screen by disposing the one or more display components created by the display component creating circuitry,
wherein the display component creating circuitry is configured to change content of each of the one or more display components in accordance with one or more parameters, and
wherein the confirmation screen creating circuitry is configured to select, using the one or more parameters, content of each of the one or more display components in the confirmation screen.

2. The data visualization apparatus according to claim 1,
wherein the confirmation screen creating circuitry is configured to create the confirmation screen in which a plurality of types of display components are disposed using the one or more parameters.

3. The data visualization apparatus according to claim 1,
wherein the confirmation screen creating circuitry is configured to create a plurality of the confirmation screens, and
wherein the processing circuitry is configured to perform processing that causes one screen to display a list of one or more types of the one or more display components and a list of types of the confirmation screens and further performs, in accordance with an operation by a user, processing that causes display of the one or more display components constituting each of the confirmation screens such that the one or more display components are recognizable.

4. The data visualization apparatus according to claim 1,
wherein the processing circuitry is configured to perform processing to display an editing screen for the one or more display components and displays, on the editing screen, a usage status of the one or more display components in the confirmation screen.

5. The data visualization apparatus according to claim 1,
wherein the data obtaining circuitry further obtains identification information of a user, and
wherein the data visualization apparatus further comprises
restriction circuitry configured to limit, in update of the one or more display components by the display component creating unit, the update performed by a user different from a user who has created the one or more display components, based on the identification information obtained by the data obtaining circuitry.

6. A data visualization apparatus comprising:
data obtaining circuitry configured to obtain target data from a database, the target data being at least one of measurement data or a calculation result of calculation using the measurement data; and
processing circuitry configured to perform, based on the target data obtained by the data obtaining unit, processing that creates a confirmation screen including the measurement data or the calculation result and processing that causes the confirmation screen to be displayed,
wherein the processing circuitry includes
display component creating circuitry configured to create or update one or more display components constituting the confirmation screen, and
confirmation screen creating circuitry configured to create or update the confirmation screen by disposing the one or more display components created by the display component creating circuitry,
wherein the confirmation screen creating circuitry is configured to create a plurality of the confirmation screens, and
wherein the processing circuitry performs processing that causes one screen to display a list of one or more types of the one or more display components and a list of types of the confirmation screens.

7. A data processing method for a data visualization apparatus, the data processing method comprising:
obtaining target data from a database, the target data being at least one of measurement data or a calculation result of calculation using the measurement data;
performing, based on the target data that has been obtained, processing of creating a confirmation screen including the measurement data or the calculation result and processing of causing the confirmation screen to be displayed;
creating or updating one or more display components constituting the confirmation screen; and
creating or updating the confirmation screen by disposing the one or more display components,
wherein content of each of the one or more display components is changed in accordance with one or more parameters, and
wherein content of each of the one or more display components in the confirmation screen is selected using the one or more parameters.

8. A data processing method for a data visualization apparatus, the data processing method comprising:
obtaining target data from a database, the target data being at least one of measurement data or a calculation result of calculation using the measurement data;
performing, based on the target data that has been obtained, processing of creating a confirmation screen including the measurement data or the calculation result and processing of causing the confirmation screen to be displayed;
creating or updating one or more display components constituting the confirmation screen; and
creating or updating the confirmation screen by disposing the one or more display components,
wherein a plurality of the confirmation screens are created, and
wherein processing of causing one screen to display a list of one or more types of the one or more display components and a list of types of the confirmation screens is performed.

9. A non-transitory computer-readable storage medium that stores therein a data processing program that when executed on a data visualization apparatus, causes the data visualization apparatus to execute instructions that perform the method of claim 7.

10. A non-transitory computer-readable storage medium that stores therein a data processing program that when executed on a data visualization apparatus, causes the data visualization apparatus to execute instructions that perform the method of claim 8.

11. The data visualization apparatus according to claim 2,
wherein the confirmation screen creating circuitry is configured to create a plurality of the confirmation screens, and
wherein the processing circuitry is configured to perform processing that causes one screen to display a list of one or more types of the one or more display components and a list of types of the confirmation screens and further performs, in accordance with an operation by a user, processing that causes display of the one or more display components constituting each of the confirmation screens such that the one or more display components are recognizable.

12. The data visualization apparatus according to claim 2,
wherein the processing circuitry is configured to perform processing to display an editing screen for the one or more display components and displays, on the editing screen, a usage status of the one or more display components in the confirmation screen.

13. The data visualization apparatus according to claim 3,
wherein the processing circuitry is configured to perform processing to display an editing screen for the one or more display components and displays, on the editing screen, a usage status of the one or more display components in the confirmation screen.

14. The data visualization apparatus according to claim 2,
wherein the data obtaining circuitry further obtains identification information of a user, and
wherein the data visualization apparatus further comprises
restriction circuitry configured to limit, in update of the one or more display components by the display component creating unit, the update performed by a user different from a user who has created the one or more display components, based on the identification information obtained by the data obtaining circuitry.

15. The data visualization apparatus according to claim 3,
wherein the data obtaining circuitry further obtains identification information of a user, and
wherein the data visualization apparatus further comprises
restriction circuitry configured to limit, in update of the one or more display components by the display component creating unit, the update performed by a user different from a user who has created the one or more display components, based on the identification information obtained by the data obtaining circuitry.

16. The data visualization apparatus according to claim 4,
wherein the data obtaining circuitry further obtains identification information of a user, and
wherein the data visualization apparatus further comprises
restriction circuitry configured to limit, in update of the one or more display components by the display component creating unit, the update performed by a user different from a user who has created the one or more display components, based on the identification information obtained by the data obtaining circuitry.
